(19) United States
(12) Patent Application Publication
(10) Pub. No.: US 2019/0059361 A1
(43) Pub. Date: Feb. 28, 2019

(54) METHODS AND COMPOSITIONS FOR THE PRESERVATION OF TISSUE

(71) Applicant: FORM 62 LLC, San Jose, CA (US)

(72) Inventors: Robert MCINTYRE, San Jose, CA (US); Michael MCCANNA, San Francisco, CA (US)

(21) Appl. No.: 16/113,813

(22) Filed: Aug. 27, 2018

Related U.S. Application Data
(60) Provisional application No. 62/550,945, filed on Aug. 28, 2017.

(51) Int. Cl. A01N 1/02

(52) U.S. Cl. CPC A01N 1/0221; A01N 1/0226

(57) ABSTRACT

Described herein are methods of preserving a tissue of a subject, such as a brain or a portion thereof. The methods include washing the tissue by perfusing the tissue with a wash fluid comprising an aqueous solution; fixing the tissue by perfusing the tissue with a fixation fluid comprising an aldehyde; and cryoprotecting the tissue by perfusing the tissue with a cryoprotection fluid comprising a vitrification agent. The wash fluid, the fixation fluid, and/or the cryoprotection fluid can include a dye or a contrast agent to monitor perfusion of the fluid through the tissue. In certain embodiments, the cryoprotection fluid has a vitrification temperature of about −80° C. or higher. The wash fluid can further include one or more of an ion channel blocker, a calcium chelator, a thrombolytic agent, an anti-platelet, a respiratory poison, or a synaptic poison. Also described herein are methods of analyzing the preserved tissue.

### CROSS-REFERENCE TO RELATED APPLICATION

This application claims priority benefit to U.S. Provisional Patent Application No. 62/550,945, filed Aug. 28, 2017, the entire contents of which are incorporated herein by reference.

### TECHNICAL FIELD

The invention described herein relates to methods and compositions for preservation of tissue, particularly brain tissue.

### BACKGROUND

The ability to fix and preserve tissue to maintain structures is important for maintaining clinical and scientific tissue samples in the long-term for study. Neural tissue, including whole brain banking from human and non-human (such as rodent) sources, is especially important for the study of many brain diseases such as Alzheimer's disease. See, for example, Samarasekera et al., Brain banking for neurological disorders, Lancet Neurology, vol. 12, no. 11, pp. 1096-1105 (2013).

Unfortunately, brain-banking technology has not changed much since the 1960s. Human brains are generally preserved via immersion in formalin, generally after a long ischemic delay lasting anywhere from 16-36 hours. Unfortunately, this combination of ischemic delay (stagnant blood flow), formalin fixation, and slow diffusion-based infiltration of fixative leads to substantial ultrastructural damage and loss of protein and/or RNA even before samples are analyzed.

Other methods of preserving brains include perfusing the brain with aldehydes and storing the fixed brain at a relatively warm temperature (such as about 4° C.). However this technique does not guarantee static preservation of the brain ultrastructure for long term-storage because the fixed brain remains chemically active and can undergo chemical and morphological degradation. Storage of the fixed brain at sub-zero temperatures acts to inhibit chemical degradation, but the formation of ice will cause significant dehydration and mechanical damage to the ultrastructure of the brain.

A recently developed technique for the preservation of animal brains called aldehyde-stabilized cryopreservation (ASC) promises to greatly improve the preservation quality and storage times for preserved brains. See McIntyre & Fahy, Aldehyde-stabilized cryopreservation, Cryobiology, vo. 71, pp. 448-458 (2015). ASC delivers glutaraldehyde via perfusion, enabling rapid fixation of all brain structures. A cryoprotectant is then introduced, enabling long-term storage at very low temperatures. There are still many shortcomings of the ASC process, including structural quality, storage temperature, and quality control. For example, perfusion of tissue with a fixation fluid can result in muscle or tissue contraction or edemas, which limits perfusion of the fluid into capillary beds. Further, preservation using the ASC methods can result in a loss of extracellular space, loss of docked neurotransmitter vesicles, unraveling of myelin, reorganization of the cytoskeleton, and overall tissue shrinkage.

The disclosures of all publications, patents, and patent applications referred to herein are hereby incorporated herein by reference in their entireties.

### SUMMARY OF THE INVENTION

Described herein are methods of preserving a tissue (such as a brain) and methods of analyzing a preserved tissue. Also described herein are wash fluids, fixation fluids, and cryoprotection fluids that may be used to preserve a tissue.

In one aspect, a method of preserving a tissue of a subject comprises washing the tissue by perfusing the tissue with a wash fluid comprising an aqueous liquid (such as saline or buffered saline); fixing the tissue by perfusing the tissue with a fixation fluid comprising an aldehyde; and cryoprotecting the tissue by perfusing the tissue with a cryoprotection fluid comprising a vitrification agent; the wash fluid, the fixing fluid, or the cryoprotection fluid comprising a dye or a contrast agent.

In another aspect, a method of preserving a tissue of a subject comprises washing the tissue by perfusing the tissue with a wash fluid comprising an aqueous liquid (such as saline or buffered saline); fixing the tissue by perfusing the tissue with a fixation fluid comprising an aldehyde; and cryoprotecting the tissue by perfusing the tissue with a cryoprotection fluid comprising a vitrification agent, the cryoprotection fluid having a vitrification temperature of about −80° C. or higher.

In another aspect, a method a method of preserving a tissue of a subject comprises washing the tissue by perfusing the tissue with a wash fluid comprising (1) an aqueous liquid (such as saline or buffered saline), and (2) any one or more of an ion channel blocker, a calcium chelator, a thrombolytic agent, an anti-platelet, a respiratory poison, or a synaptic poison; fixing the tissue by perfusing the tissue with a fixation fluid comprising an aldehyde; and cryoprotecting the tissue by perfusing the tissue with a cryoprotection fluid comprising a vitrification agent.

In another aspect, a method of preserving a tissue of a subject comprises washing the tissue by perfusing the tissue with a wash fluid comprising an aqueous liquid (such as saline or buffered saline); fixing the tissue by perfusing the tissue with a fixation fluid comprising an aldehyde; and cryoprotecting the tissue by perfusing the tissue with a cryoprotection fluid comprising a vitrification agent; wherein the washing is initiated after onset of ischemia in the tissue.

In some embodiments of the methods described above, the wash fluid, the fixation fluid, or the cryoprotection fluid comprises a dye or a contrast agent.

In some embodiments of the methods described above, the wash fluid, the fixation fluid, or the cryoprotection fluid comprises a radiopaque dye.

In some embodiments of the methods described above, the method further comprises monitoring by imaging a distribution of the wash fluid, the fixation fluid, or the cryoprotection fluid in the tissue.

In another aspect, a method of preserving a tissue of a subject comprises washing the tissue by perfusing the tissue with a wash fluid comprising an aqueous liquid (such as saline or buffered saline); fixing the tissue by perfusing the tissue with a fixation fluid comprising an aldehyde; cryoprotecting the tissue by perfusing the tissue with a cryoprotection fluid comprising a vitrification agent; and monitoring by imaging a distribution of the wash fluid, the fixation fluid, or the cryoprotection fluid in the tissue.

In some embodiments of the methods described above, the monitoring is performed by computed tomography (CT), micro computed tomography (microCT), X-Ray, or magnetic resonance imaging (MRI).

In some embodiments of the methods described above, perfusion of the tissue with the wash fluid, the fixation fluid, or the cryoprotection fluid is performed according to a perfusion schedule, wherein the perfusion schedule is modified based on the monitored distribution of the wash fluid, the fixation fluid, or the cryoprotection fluid.

In some embodiments of the methods described above, the method further comprises vitrifying the tissue. In some embodiments, the tissue is vitrified to a temperature of about −100° C. or colder. In some embodiments, the method comprises storing the vitrified tissue for about 72 hours or longer. In some embodiments, the method comprises thawing the vitrified tissue.

In some embodiments of the methods described above, the method comprises imaging at least a portion of the preserved tissue.

In some embodiments of the methods described above, the method comprises characterizing at least a portion of the preserved tissue through a microanatomical analysis.

In some embodiments of the methods described above, at least a portion of the preserved tissue is imaged using electron microscopy, expansion microscopy, or fluorescence in situ hybridization (FISH) expansion microscopy.

In one aspect provided herein, a method of analyzing a preserved tissue from a subject comprises imaging or performing a microanatomical analysis on the preserved tissue, the tissue having been preserved by: washing the tissue by perfusing the tissue with a wash fluid comprising an aqueous liquid (such as saline or buffered saline); fixing the tissue by perfusing the tissue with a fixation fluid comprising an aldehyde; cryoprotecting the tissue by perfusing the tissue with a cryoprotection fluid comprising a vitrification agent; and monitoring a distribution of the wash fluid, the fixation fluid, or the cryoprotection fluid during the perfusing of the tissue.

In another aspect provided herein, a method of analyzing a preserved tissue from a subject comprises imaging or performing a microanatomical analysis on the preserved tissue, the tissue having been preserved by washing the tissue by perfusing the tissue with a wash fluid comprising an aqueous liquid (such as saline or buffered saline); fixing the tissue by perfusing the tissue with a fixation fluid comprising an aldehyde; and cryoprotecting the tissue by perfusing the tissue with a cryoprotection fluid comprising a vitrification agent, the cryoprotection fluid having a vitrification temperature of about −80° C. or higher.

In another aspect provided herein, a method of analyzing a preserved tissue from a subject comprises imaging or performing a microanatomical analysis on the preserved tissue, the tissue having been preserved by: washing the tissue by perfusing the tissue with a wash fluid comprising an aqueous liquid (such as saline or buffered saline), an ion channel blocker, a calcium chelator, a thrombolytic agent, a respiratory poison, a synaptic poison, and a vasodilator; fixing the tissue by perfusing the tissue with a fixation fluid comprising an aldehyde; and cryoprotecting the tissue by perfusing the tissue with a cryoprotection fluid comprising a vitrification agent.

In some embodiments of the methods described above, a distribution of the wash fluid, the fixation fluid or the cryoprotection fluid in the tissue was monitored during perfusion of the tissue. In some embodiments, perfusion of the tissue was monitored using CT, microCT, X-Ray, or MRI.

In some embodiments of the methods described above, the method comprises thawing the preserved tissue.

In some embodiments of the methods described above, imaging or performing the microanatomical analysis on the preserved tissue comprises imaging the preserved tissue using electron microscopy, focused ion beam microscopy, expansion microscopy, or fluorescence in situ hybridization (FISH) microscopy.

In some embodiments of the methods of analyzing the preserved tissue from a subject described above, perfusion of the tissue with the wash fluid, the fixation fluid, or the cryoprotection fluid was performed according to a perfusion schedule, wherein the perfusion schedule was modified based on the distribution of the wash fluid, the fixation fluid, or the cryoprotection fluid during perfusion of the tissue.

In some embodiments of the methods described above, the cryoprotection fluid is perfused into the tissue as a gradient against the fixation fluid.

In some embodiments of the methods described above, the wash fluid, the fixation fluid, or the cryoprotection fluid comprises an ion channel blocker or an ion receptor blocker.

In some embodiments of the methods described above, the fixation fluid, or the cryoprotection fluid comprises a calcium chelator.

In some embodiments of the methods described above, the wash fluid, the fixation fluid, or the cryoprotection fluid comprises a respiratory poison.

In some embodiments of the methods described above, the wash fluid, the fixation fluid, or the cryoprotection fluid comprises a synaptic poison.

In some embodiments of the methods described above, the wash fluid, the fixation fluid, or the cryoprotection fluid comprises a vasodilator.

In some embodiments of the methods described above, the wash fluid, the fixation fluid, or the cryoprotection fluid comprises an oncotic agent.

In some embodiments of the methods described above, the wash fluid or the fixation fluid comprises an ionic surfactant.

In some embodiments of the methods described above, the wash fluid comprises an anesthetic.

In some embodiments of the methods described above, the wash fluid comprises a thrombolytic agent.

In some embodiments of the methods described above, the wash fluid comprises an anticoagulant.

In some embodiments of the methods described above, the wash fluid comprises an antiplatelet agent.

In some embodiments of the methods described above, the fixation fluid comprises formaldehyde or glutaraldehyde.

In some embodiments of the methods described above, the cryoprotection fluid comprises an aldehyde.

In some embodiments of the methods described above, the cryoprotection fluid comprises ethylene glycol, dimethyl sulfoxide, glycerol, or polyethylene glycol.

In some embodiments of the methods described above, the cryoprotection fluid has a vitrification temperature of about −195° C. to about +50° C.

In some embodiments of the methods described above, the tissue is preserved within 8 hours of the subject's death.

In some embodiments of the methods described above, the subject is a human. In some embodiments, the subject is a non-human animal. In some embodiments, the non-human animal is a rodent.

In some embodiments of the methods described above, the tissue is an organ or a portion thereof. In some embodiments, the tissue is a brain or a portion thereof. In some embodiments, the volume of the tissue is about 100 cm³ or larger.

Further provided herein is a preserved tissue formed according to any one of the methods described above.

Further described herein is a fixation fluid for fixing a tissue by perfusion, comprising (1) an aldehyde, and (2) a dye or a contrast agent. In some embodiments, the aldehyde is formaldehyde or glutaraldehyde.

Further described herein is a cryoprotection fluid for cryopreserving a tissue, comprising (1) a vitrification agent, and (2) a dye or a contrast agent. In some embodiments, the cryoprotection fluid comprises an aldehyde. In some embodiments, the cryoprotection fluid comprises ethylene glycol, glycerol, dimethyl sulfoxide, polyethylene glycol. In some embodiments, the cryoprotection fluid has a vitrification temperature of about −195° C. to about +50° C.

### BRIEF DESCRIPTION OF THE FIGURES

FIG. 1 illustrates an exemplary setup for perfusing a brain in a subject with a wash fluid. The wash fluid is perfused through the carotid arteries of the subject and fluid is drained from the jugular vein.

FIG. 2A-2F illustrates an exemplary method of preserving a brain in a subject. At FIG. 2A, wash fluid is perfused into the brain of the subject. At FIG. 2B, a first stage fixation fluid (FIX*) is perfused into the subject. At FIG. 2C, the setup is primed with a second stage fixation fluid (FIX). At FIG. 2D the second stage fixation fluid is perfused into the brain of the subject as a gradient against the first stage fixation fluid (FIX*). At FIG. 2E, the second stage fixation fluid is perfused into the brain of the subject without the first stage fixation fluid. At FIG. 2F, the cryoprotection fluid (CPA) is perfused into the brain of the subject as a gradient against the second stage fixation fluid.

FIGS. 3A-3L show electron microscopy images of preserved brain tissue. FIG. 3A shows an inverted contrast image from a cortex sample, which shows good preservation and high retention of nuclear material (A) and myelin (B, C). FIG. 3B is an electron microscopy image of a cortex sample, showing a blood vessel (A), multiple processes (i.e., multiple branches of the neuron) (B), and well preserved ground substance (C). Some damage (D) was also visible. FIG. 3C shows an additional electron microscopy image of a cortex sample with well-preserved synapses (A), myelinated processes (B), unmylenated processes (C), and some damaged areas (D, E). FIG. 3D is an electron microscopy image showing multiple pyramidal cells (A) and multiple myelinated processes (B). FIG. 3E shows multiple synapses (A, B, C) within the uranium acetate stained cortex sample obtained using scanning electron microscopy. FIG. 3F is an electron microscopy image of an amygdala, showing multiple synapses (A) and fine processes, as well as several expanded mitochondria (B). FIG. 3G is a focused ion beam milling image of a cortex sample coated with a 20 micrometer layer of resin milled to reveal the brain tissue. FIG. 3H is a focused ion beam milling image of a corpus callosum sample coated with a layer of resin milled to reveal the brain tissue. FIG. 3I is an electron microscopy image of a uranium acetate stained cortex that shows myelin and partially-disrupted incisures (A, B, C). FIG. 3J is a focused ion beam scanning electron microcopy (FIB-SEM) image of a hippocampus sample showing well preserved myelinated processes (A, B). FIG. 3K shows an image from a cortex sample within a resin block. Although the preservation of brain tissue is better preserved than previous studies, some damage to the brain ultrastructure was observed. For example, in FIG. 3J, some loss of intracellular components were observed (C). FIG. 3L is an electron microscopy image of a uranium acetate stained cortex sample showing disrupted myelin (A) in several parallel processes, as well as normal myelin (B).

### DETAILED DESCRIPTION OF THE INVENTION

Described herein is a method of preserving tissue from a subject. In certain embodiments, the tissue is an intact organ, such as a brain. The tissue is washed by perfusing the tissue with a wash fluid, fixed by perfusing the tissue with a fixation fluid, and cryoprotected by perfusing the tissue with a cryoprotection fluid. The wash fluid flushes blood and/or coagulants from the vessels within the tissue. In some embodiments, the wash fluid includes components that can facilitate perfusion, for example by dilating blood vessels or dissolving blood clots. In some embodiments, the wash fluid includes components that can minimize unintended effects of the fixation fluid. The fixation fluid fixes the tissue by forming crosslinks within the tissue, which helps preserve the tissue and limits decay (in addition to vitrifying the tissue). The cryopreservation fluid provides a vitrification agent to the tissue, which suppresses the formation of ice crystals upon cooling the tissue for storage. Once the tissue has been perfused with the wash fluid, fixation fluid, and the cryoprotection fluid, the tissue can be vitrified at low temperatures and stored. The vitrified tissue can then be thawed for analysis, for example by imaging the tissue. Also described herein are methods of analyzing a preserved tissue, as well as wash fluids, fixation fluids, and cryoprotection fluids.

Careful preservation of brains, or portions thereof, can allow for a more detailed microanatomical analysis of the tissue and a better understanding of neurological connections. This can help with brain mapping and development of the connectome, a comprehensive map of neural connections within the brain. For example, the methods described herein allow for the preservation of one or more of ground substance nanostructure, myelin nanostructure, pyramidal cell nanostructure, or nerve synapse nanostructure within brain tissue. Although recent research has led to substantial increases in maintaining structural integrity of preserved tissue, continued progress is needed to better resolve tissue microanatomy.

Many tissues and organs, such as the brain, include a complex network of blood vessels. Fluids, such as the wash fluid, fixation fluid, and the cryoprotection fluid perfused into the tissue flows through the blood vessels to reach the various portions of the tissue. Incomplete perfusion of the fluids can result in poor preservation of the tissue. In older and/or unhealthy tissue samples, focal obstructions in the vasculature may greatly delay or even prevent adequate washing, fixation, and/or cryoprotection of tissue during perfusion. Previous methods relied on a fixed schedule to perfuse samples, and assumed the fluids were uniformly delivered to the tissue. While these previous practices function for laboratory demonstrations, this level of quality control is not acceptable for robust, repeatable preservation of whole tissue or whole organ samples. Dynamic monitoring during perfusion can allow for corrective actions such as surgical repair of damaged vessels or extending the time of fluid perfusion to ensure that large osmotic gradients are avoided and that the fluid is delivered in sufficient quantities to all tissue regions. By including a dye (such as a radiopaque dye) or contrast agent in the wash fluid, fixation fluid, cryoprotection fluid, or any other fluid perfused into the tissue described herein, perfusion can be monitored by imaging the distribution of the fluid in the tissue. Exemplary contrast agents or radiopaque dyes include, but are not limited to, iodide salts (such as potassium iodide or sodium iodide), barium salts (such as barium chloride), chelate complex with heavy metals (such as lead or gold), or gadolinium. In some embodiments the distribution is monitored by CT, microCT, X-Ray, or MRI. In some embodiments, the method includes performing corrective surgery on the tissue to unclog or bypass clogged vessels. Adequate monitoring ensures that the tissue is fully perfused with the fluid before the next step of preservation occurs.

Additionally, the inclusion of certain compounds in the wash fluid, fixation fluid, and/or the cryoprotection fluid can help better preserve the tissue, as discussed in further detail herein. For example, in some embodiments the wash fluid, fixation fluid and/or cryoprotection fluid includes one or more of an ion channel blocker, an ion receptor blocker, a calcium chelator, a respiratory poison, a synaptic poison, a vasodilator, an oncotic agent, an anesthetic, a thrombolytic agent (also referred to as a “clot busting agent”), an antiplatelet, an ionic surfactant, or an anticoagulant. These compounds enhance preservation of the tissue, for example, by increasing the perfusion efficiency or stabilizing the tissue microstructure during the preservation process.

As used herein, the singular forms “a,” “an,” and “the” include the plural reference unless the context clearly dictates otherwise.

Reference to “about” a value or parameter herein includes (and describes) variations that are directed to that value or parameter per se. For example, description referring to “about X” includes description of “X”.

An “anticoagulant” is any one or more compounds that directly or indirectly inhibits coagulation factor activity and suppresses coagulation of blood.

An “antiplatelet agent” is any one or more compounds that decrease platelet aggregation.

The term “death” of a subject refers to a clinical death of the subject defined by a complete loss of respiratory activity, heartbeat, and brain activity.

The terms “ion channel blocker” and “ion receptor blocker” are used synonymously to refer to any one or more compounds that suppresses the transport of one or more ions (e.g., sodium, potassium, calcium, etc.) across a cellular membrane by way of an ion channel or ion receptor.

The term “ischemia” refers to a state of a tissue wherein oxygen supplied to the tissue is inadequate to maintain functionality of the tissue.

The term “microanatomical analysis” refers to the evaluation of physical structures of biological tissue at a microscopic or submicroscopic level of resolution.

The term “nanostructure” as used herein refers to a physical structure of a biological system that is less than 100 nanometers in the smallest dimension.

An “oncotic agent” is any one or more compounds that increases the osmotic pressure of a liquid within a blood vessel.

The term “perfusing” or “perfusion” refers to delivering a fluid to a tissue by administering the fluid to the tissue under pressure through one or more vessels that leads to or is within the tissue.

A “respiratory poison” is any one or more compounds that suppress biochemical respiration, and includes electron transport inhibitors, uncoupling agents, and proton channel blockers.

A “synaptic poison” is any one or more compounds that suppresses the release of docked neurotransmitter vesicles from a neuron at a neurological synapse.

A “thrombolytic agent” or a “clot busting agent” is any one or more serine proteases that convert plasminogen to plasmin to break down fibrinogen and fibrin, and enhances the dissociation of a blood clot (thrombus) in a blood vessel.

A “vasodilator” is any one or more compounds that that dilate blood vessels.

The terms “vitrification agent,” “cryoprotection agent,” and “cryoprotectant” are used interchangeably, and refer to any one or more compounds that protect biological samples from freezing damage by limiting the formation of ice crystals during cooling.

The “vitrification temperature” or “glass transition temperature” refers to the temperature below which a material acts as an amorphous solid and above which the material acts as a viscous liquid or rubbery material. The vitrification temperature is determined by dynamic mechanical analysis according to ASTM E1356-08 (2014), Standard Test Method for Assignment of the Glass Transition Temperatures by Differential Scanning Calorimetry.

It is understood that aspects and variations of the invention described herein include “consisting” and/or “consisting essentially of” aspects and variations.

Where a range of values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

It is to be understood that one, some or all of the properties of the various embodiments described herein may be combined to form other embodiments of the present invention. The section headings used herein are for organizational purposes only and are not to be construed as limiting the subject matter described.

Tissues preserved or analyzed by the methods described herein include organs, including whole organs or portions thereof. Exemplary organs include, but are not limited to, a brain, a bladder, a heart, a gallbladder, an intestine (such as a large intestine or small intestine), a kidney, a liver, a lung, an ovary, a pancreas, a prostate, a spleen, a stomach, a thymus, or a uterus. In some embodiments, the tissue is a neurological tissue. In some embodiments, the portion of the brain comprises, is, or is a portion of the cerebrum, the cerebral cortex, the corpus callosum, the frontal lobe, the parietal lobe, the occipital lobe, the thalamus, the epithalamus, the pineal gland, the hypothalamus, the pituitary gland, the subthalamus, the hippocampus, the claustrum, the cerebellum, the temporal lobe, the brainstem, the pons, the midbrain, or the medulla oblongata. In some embodiments, whole animals are preserved.

The methods described herein allow for the preservation of large, intact tissues, including organs. Large organs contain variations in vasculature, and do not always perfuse evenly when a predefined perfusion schedule is used. The methods described herein, including dynamically monitoring perfusion of the fluids in the tissue, allow for larger tissues to be preserved with high quality. In some embodiments, the preserved tissue has a volume of about 100 cm³ or larger (such as about 120 cm³ or larger, about 150 cm³ or larger, about 200 cm³ or larger, about 400 cm³ or larger, about 600 cm³ or larger, about 800 cm³ or larger, about 1000 cm³ or larger, or about 1200 cm³ or larger).

The tissue is from a subject, such as a vertebrate. In some embodiments, the subject is a mammal, such as a human or a non-human animal. Exemplary non-human animals include, but are not limited to rodents (such as mice, rates, guinea pigs, or hamsters), non-human primates (such as monkeys, apes, chimpanzees, baboons, or gorillas), a chicken, a bovine animal, a pig, a cat, a dog, or a rabbit. In some embodiments, the tissue is removed from the animal prior to preservation. In some embodiments, the tissue is preserved in place in the animal (i.e., in situ). In some embodiments, the subject is deceased prior to preservation of the tissue. In some embodiments, the subject is euthanized during the preservation process. Preferably, if the subject is euthanized during the preservation process, the subject is anesthetized prior to the preservation process. In some embodiments, the method includes removing the tissue from the subject, either before or after preservation of the tissue.

Fluids, such as the wash fluid, the fixation fluid, or the cryoprotection fluid are perfused into the tissue. In some embodiments, the fluid is perfused into the tissue through the circulatory system and/or the lymphatic system. In some embodiments, the one or more fluids are perfused into the tissue through an artery leading into the tissue or organ, and fluid is drained out of a vein coming from the tissue or organ. For example, in some embodiments, perfusion of a brain includes perfusing fluid into a carotid artery (such as a common carotid artery, an inner carotid artery, or an outer carotid artery) and fluid is drained from a jugular vein (such as an internal jugular vein or an external jugular vein).

Perfusion of a tissue includes delivering fluid into the tissue and draining fluid from the tissue. This allows for a fluid replacement. For example a wash fluid is delivered into the tissue and blood is drained from the tissue during a washing step. During the fixing step of the tissue, the fixing fluid is delivered into the tissue and the wash fluid is drained from the tissue. During the cryoprotecting step, the cryoprotection fluid is delivered to the tissue and the fixing fluid is drained from the tissue. Moving a washing step or fixing step to the next step in the process (i.e., the fixing step or the cryoprotection step) can occur discretely (i.e., an immediate switch from perfusing wash fluid into the tissue to perfusing fixing fluid into the tissue, or from perfusing fixing fluid into the tissue to perfusing cryoprotection fluid into the tissue) or as a gradient (i.e., incrementally increasing the proportion of fixing fluid or cryoprotection fluid delivered to the tissue). Drained fluid can either be disposed or recirculated through the tissue. For example, in some embodiments, fixing fluid delivered to the tissue drains from the tissue and is recirculated into the tissue during the perfusing step.

### Wash Fluid and Washing of Tissue

The tissue is washed by perfusing the tissue with a wash fluid. The wash fluid is a aqueous solution that can include one or more compounds, such as compounds for dilating blood vessels, dissolving blood clots, or preparing the tissue for fixation. The wash fluid is pumped into the tissue, for example through an artery, and fluid drained from the tissue, for example through a vein. Washing of the tissue using the wash fluid clears red blood cells from the tissue. Red blood cells remaining in the tissue during the fixing step can result in increased rigidity and blockage of capillary beds. A first cannula can be inserted into the artery to deliver the wash fluid, and a second cannula can be inserted into the vein or the vein can be cut to drain the fluid. The fluid drained from the tissue can include a mixture of blood and wash fluid, or once the blood has been drained, the wash fluid. In some embodiments, the fluid drained from the tissue is disposed of after drainage.

The wash fluid can include aqueous liquid suitable for washing the tissue to remove blood. In some embodiments, the wash fluid comprises a crystalloid-based solution, such as a saline solution. In some embodiments, the wash fluid is buffered. In some embodiments, the aqueous solution is a saline, such as a buffered saline or isotonic saline. Exemplary buffered saline solutions include phosphate buffered saline or Krebs-Ringer's solution. In some embodiments, the wash fluid is isotonic or approximately isotonic with the osmolarity of the blood from the subject. The wash fluid can include salts, such as sodium chloride, potassium chloride, magnesium chloride, or calcium chloride. In some embodiments, the wash fluid includes one or more buffers, such as phosphate buffer (such as sodium phosphate or potassium phosphate), sodium carbonate, or HEPES. In some embodiments, the wash fluid includes one or more additives to further condition the tissue for the fixation fluid. Exemplary additives include, but are not limited to, an ion channel blocker, an ion receptor blocker, a calcium chelator, a respiratory poison, a synaptic poison, a vasodilator, an oncotic agent, an anesthetic, a thrombolytic agent, an antiplatelet agent, an ionic surfactant, and/or an anticoagulant.

In some embodiments, the pH of the wash fluid is between about 7 and about 8 (such as about 7.2 to about 7.8, or about 7.4 to about 7.6).

During the fixing step of tissue preservation, ion channels can open or be otherwise disrupted, resulting in large fluxes of ions across cell membranes. The large flux of ions can result in structural alterations, such as loss of extracellular space in the tissue or vacuolization of mitochondria. To condition the tissue in preparation for the fixation fluid, in some embodiments the wash fluid includes an ion channel blocker or an ion receptor blocker. Exemplary ion channel blockers or ion receptor blockers include, but are not limited to, a conotoxin (such as α-conotoxin, γ-conotoxin, κ-conotoxin, ω-conotoxin, or μ-conotoxin, which act to block acetylcholine channels, sodium channels, potassium channels, and calcium channels), tetrodotoxin (which acts to block sodium channels), a conantokin (such as conantokin-G, conantokin-T, conantokin-R, conantokin-P, or conantokin-E, which inhibit the N-methyl-D-aspartate receptor (NMDAR)), curare (which blocks acetylcholine channels), or barium (which blocks potassium channels). In some embodiments, the ion channel blocker or the ion receptor blocker is included in the wash fluid at a concentration of about 50 ng/L or more (such as about 100 ng/L or more, about 250 ng/L or more, about 500 ng/L or more, about 1 μg/L or more, about 2.5 μg/L or more, about 5 μg/L or more, about 10 μg/L or more, about 25 μg/L or more, about 50 μg/L or more, about 100 μg/L or more, about 250 μg/L or more, about 500 μg/L or more, about 1 mg/L or more, about 2.5 mg/L or more, about 5 mg/L or more, about 10 mg/L or more, about 25 mg/L or more, about 50 mg/L or more, about 100 mg/L or more, or about 250 mg/L or more). In some embodiments, the ion channel blocker or the ion receptor blocker is include in the wash fluid at a concentration of about 500 mg/L or less (such as about 250 mg/L or less, about 100 mg/L or less, about 50 mg/L or less, about 25 mg/L or less, about 10 mg/L or less, about 5 mg/L or less, about 2.5 mg/L or less, about 1 mg/L or less, about 500 μg/L or less, about 250 μg/L or less, about 100 μg/L or less, about 50 μg/L or less, about 25 μg/L or less, about 10 μg/L or less, about 5 μg/L or less, about 2.5 μg/L or less, about 1 μg/L or less, about 500 ng/L or less, about 250 ng/L or less, or about 100 ng/L or less). In some embodiments, the wash fluid includes a combination of ion channel blockers and/or ion receptor blockers. Solely by way of example, in some embodiments the wash fluid include a conotoxin (such as κ-conotoxin) at a concentration of about 50 ng/L to about 5 μg/L, tetrodotoxin at a concentration of about 500 ng/L to about 25 mg/L, conantokin-G at a concentration of about 250 ng/L to about 10 mg/L, and curare at a concentration of about 5 mg/L to about 50 mg/L.

Without conditioning the tissue, introduction of the fixation fluid to the tissue can cause muscle contractions (also referred to as “fixation tremors”), which can cause disruption of the perfusion (for example, by closing capillaries or ejecting the perfusing cannula) or distortions of organs. See, for example, Gage et al., Whole Animal Perfusion Fixation for Rodents, J. Visualized Experiments, vol. 65, e3564 (2012). To suppress the fixation tremors, a calcium chelator can be included in the wash fluid. The calcium chelator can also act to prevent early stages of the ischemic cascade in neurons and other cells that self-destruct with an influx of calcium. Additionally, calcium chelators can interfere with blood clotting, which would otherwise result in incomplete blood washout or poor perfusion throughout the tissue. Exemplary calcium chelators include, but are not limited to, ethylenediaminetetraacetic acid (EDTA), egtazic acid (EGTA), 1,2-bis(o-aminophenoxy)ethane-N,N,N′,N′-tetraacetic acid (BAPTA), or citrate. In some embodiments, the calcium chelator is included in the wash fluid at a concentration of about 0.1 g/L or higher (such as about 0.25 g/L or higher, about 0.5 g/L or higher, about 1 g/L or higher, about 2 g/L or higher, about 3 g/L or higher, or about 4 g/L or higher). In some embodiments, the calcium chelator is included in the wash fluid at a concentration of about 5 g/L or less (such as about 4 g/L or less, about 3 g/L or less, about 2 g/L or less, about 1 g/L or less, about 0.5 g/L or less, or about 0.25 g/L or less).

Many autolytic processes require energy to function, so preventing respiration by using respiratory poisons can mitigate autolytic decay or mitochondrial swelling during washout. In some embodiments, the wash fluid includes a respiratory poison. Exemplary respiratory poisons include azide (such as sodium azide) or cyanide (such as sodium cyanide). Sodium azide and sodium cyanide inhibit cytochrome c oxidase and prevent cellular respiration. In addition to minimizing autolytic changes, respiratory poisons also prevent mitochondrial vacuolization which is a common occurrence when mitochondria are exposed to certain aldehyde that may be present in the fixation fluid, such as glutaraldehyde. In some embodiments, the concentration of the respiratory poison in the wash fluid is about 0.1 g/L or higher (such as about 0.2 g/L or higher, about 0.5 g/L or higher, about 1 g/L or higher, or about 1.5 g/L or higher). In some embodiments, the concentration of the respiratory poison in the wash fluid is about 2 g/L or lower (such as about 1.5 g/L or lower, about 1 g/L or lower, about 0.5 g/L or lower, or about 0.2 g/L or lower).

Exposure of tissue to aldehydes present in the fixation fluid can result in the loss of docked vesicles in neurons. The docked vesicles contain neurotransmitter and are located in close proximity to a neural synapse. The docked vesicles provide the synapse's immediately available stock of neurotransmitter to effect synaptic transmission. During the fixation step, these vesicles can be lost if the tissue is not pre-treated by the wash fluid. In some embodiments a synaptic poison (such as a SNARE inhibitor) is included in the wash fluid. Exemplary synaptic poisons include botulinum toxin or tetanus toxin. Botulinum toxin cleaves SNARE (soluble NSF attachment protein receptor) proteins that are required for fusion of docked vesicles to acetylcholine synapses. Tetanus toxin destabilizes SNARE proteins in the central nervous system, including in brain tissue. In some embodiments, both botulinum toxin and tetanus toxin are included in the wash fluid. In some embodiments, the concentration of the synaptic poison in the wash fluid is about 0.1 ng/L or more (such as about 0.2 ng/L or more, about 0.5 ng/L or more, about 1 ng/L or more, about 2 ng/L or more, about 5 ng/L or more, about 10 ng/L or more, about 25 ng/L or more, about 50 ng/L or more, about 100 ng/L or more, or about 150 ng/L or more). In some embodiments, the concentration of the synaptic poison in the wash fluid is about 200 ng/L or less (such as about 150 ng/L or less, about 100 ng/L or less, about 50 ng/L or less, about 25 ng/L or less, about 10 ng/L or less, about 5 ng/L or less, about 2 ng/L or less, about 1 ng/L or less, about 0.5 ng/L or less, or about 0.2 ng/L or less).

To minimize the risk of an edema in the tissue during fixation, in some embodiments an oncotic agent is included in the wash fluid. Exemplary oncotic agents include polyvinylpyrrolidone (PVP), polyethylene glycol (PEG), and hydroxyethyl starch (HES). PEG included in the wash fluid is generally a high molecular weight PEG, for example having a molecular weight of about 20,000 Da or higher (such as about 25,000 Da or higher, or about 30,000 Da or higher).

In some embodiments, an ionic surfactant (such as sodium dodecyl sulfate (SDS) or sodium dodecyl benzenesulfonate (SDBS)) is included in the wash fluid. The ionic surfactant can be used to prevent tissue shrinkage during the cryoprotection process. In some embodiments, the ionic surfactant is included in the wash fluid at a concentration of about 0.001% w/v or higher (such as about 0.002% w/v or higher, about 0.005% w/v or higher, or about 0.01% w/v or higher). In some embodiments, the ionic surfactant is included in the wash fluid at a concentration of about 0.05% w/v or lower (such as about 0.04% w/v or lower, about 0.02% w/v or lower, or about 0.01% w/v or lower).

To limit blood clotting during washing of the tissue, in some embodiments, the wash fluid comprises an anticoagulant, such as warfarin, heparin, a heparinoid, a Factor Xa inhibitor, or a thrombin inhibitor. In some embodiments, the wash fluid comprises an antiplatelet agent, such as a cyclooxygenase inhibitor (such as aspirin or triflusal), an adenosine diphosphate (ADP) receptor inhibitor (such as clopidogrel, prasugrel, ticagrelor, ticlopidine), a phosphodiesterase inhibitor (such as cilostazol), a protease-activated receptor-1 (PAR-1) antagonist (such as vorapaxar), a glycoprotein IIB/IIIA inhibitor (such as abciximab, eptifibatide, tirofiban), an adenosine reuptake inhibitor (such as dipyridamole), or a thromboxane inhibitor.

In some embodiments, the wash fluid is perfused into the tissue after the death of the subject or the onset of ischemia in the tissue. However, initiating washing of the tissue shortly after death (e.g., about 5 minutes) to about 8-12 hours after death, perfusion is complicated by blood clotting, perivascular rigor mortis, and the “no-reflow” effect. These occurrences can result in low flow rates and inconsistent tissue preservation. To allow for more efficient and complete perfusion of the wash fluid after death of the subject or the onset of ischemia in the tissue, in some embodiments the wash fluid includes one or more vasodilators, one or more thrombolytic agents, and/or adenosine triphosphate (ATP). Exemplary vasodilators include sodium nitrite, nitroglycerin, isosorbide mononitrate, isosorbide dinitrate, itramin tosilate, pentaerithrityl tetranitrate, propatylnitrate, tenitramine, trolnitrate, or molsidomine. In some embodiments, the vasodilator is included in the wash fluid at a concentration of about 0.1 g/L or more (such as about 0.2 g/L or more, about 0.5 g/L or more, or about 0.7 g/L or more). In some embodiments, the vasodilator is included in the wash fluid at a concentration of about 1 g/L or less (such as about 0.7 g/L or less, about 0.5 g/L or less, or about 0.2 g/L or less). In some embodiments, ATP is included in the wash fluid at a concentration of about 1 mM or higher (such as a concentration of about 2 mM or higher, about 5 mM or higher, about 10 mM or higher, or about 25 mM or higher). In some embodiments, ATP is included in the wash fluid at a concentration of about 50 mM or less (such as about 25 mM or less, about 10 mM or less, about 5 mM or less, or about 2 mM or less). Exemplary thrombolytic agents include tissue plasminogen activator (tPA), streptokinase, urokinase, or other clot-busting agents. In some embodiments, the wash fluid includes the thrombolytic agent at a concentration of about 0.025 mg/L or higher (such as a concentration of about 0.05 mg/L or higher, about 0.1 mg/L or higher, about 0.2 mg/L or higher, or about 0.5 mg/L or higher). In some embodiments, the wash fluid includes the thrombolytic agent at a concentration of about 1 mg/L or less (such as about 0.5 mg/L or less, about 0.2 mg/L or less, about 0.1 mg/L or less, or about 0.05 mg/L or less).

In some embodiments, the subject and/or tissue is pretreated with the thrombolytic agent (such as one or more of tissue plasminogen activator (tPA), streptokinase, urokinase, or other clot-busting agent). For example, the thrombolytic agent can be mixed with a pre-wash fluid (which can include, for example, saline) at a higher concentration than in the wash fluid and administered to the subject. In some embodiments, instead of perfusing the pre-wash fluid, the pre-wash fluid is administered by injection. In some embodiments, the pre-wash fluid is circulated by cardiopulmonary compressions (i.e., CPR compressions). In some embodiments, the concentration of the thrombolytic agent in the pre-wash fluid is about 0.1 mg/L or higher (such as about 0.2 mg/L or higher, about 0.5 mg/L or higher, about 1 mg/L or higher, or about 1.5 mg/L or higher). In some embodiments, the concentration of the thrombolytic agent in the pre-wash fluid is about 2 mg/L or less (such as about 1.5 mg/L or less, about 1 mg/L or less, about 0.5 mg/L or less, or about 0.2 mg/L or less).

In some embodiments, the subject is euthanized during perfusion of the wash fluid. In some embodiments, the wash fluid comprises an anesthetic (such as ketamine), phenytoin, and/or a barbiturate (such as pentobarbital).

In some embodiments, the wash fluid is perfused into the tissue at a pressure of about 60 mmHg to about 140 mmHg (such as about 60 mmHg to about 80 mmHg, about 80 mmHg to about 100 mmHg, about 100 mmHg to about 120 mmHg, or about 120 mmHg to about 140 mmHg).

In some embodiments, the wash fluid is cooled to below room temperature before being perfused into the tissue. In some embodiments, the wash fluid is cooled to about 20° C. or less (such as about 15° C. or less or about 10° C. or less). The wash fluid should remain above freezing temperature so that it can be perfused into the tissue.

In some embodiments the wash fluid is filtered prior to perfusion. In some embodiments, the wash fluid is sterile filtered prior to perfusion. In some embodiments, the wash fluid is filtered with a filter having an average pore size of about 0.5 μm or smaller, such as about 0.22 μm or smaller.

In some embodiments, the wash fluid is oxygenated prior to being perfused into the tissue. For example, in some embodiments, oxygen is bubbled through the wash solution for about 10 minutes or more, about 15 minutes or more, about 30 minutes or more, about 45 minutes or more, or about 1 hour or more prior to being perfused into the tissue.

Washing the tissue with the wash fluid can be initiated before, after, or at the time of death. In some embodiments, washing of the tissue is initiated about 1 minute or longer after the death of the subject (for example, about 3 minutes or longer, about 5 minutes or longer, about 15 minutes or longer, about 30 minutes or longer, about 1 hour or longer, about 2 hours or longer, about 3 hours or longer, about 6 hours or longer, or about 8 hours or longer after death). In some embodiments, washing of the tissue is initiated about 24 hours or less after death (such as about 16 hours or less, about 12 hour or less, about 8 hours or less, about 6 hours or less, about 3 hours or less, about 2 hours or less, about 1 hour or less, about 30 minutes or less, or about 15 minutes or less after death).

Washing the tissue with the wash fluid can be initiated before, after, or at the time of one or more of loss of respiratory activity, loss of heartbeat, or loss of brain activity. In some embodiments, washing of the tissue is initiated about 1 minute or longer after the loss of one or more of respiratory activity, loss of heartbeat, or loss of brain activity of the subject (for example, about 3 minutes or longer, about 5 minutes or longer, about 15 minutes or longer, about 30 minutes or longer, about 1 hour or longer, about 2 hours or longer, about 3 hours or longer, about 6 hours or longer, or about 8 hours or longer after loss of one or more of respiratory activity, loss of heartbeat, or loss of brain activity). In some embodiments, washing of the tissue is initiated about 24 hours or less after loss of one or more of respiratory activity, loss of heartbeat, or loss of brain activity (such as about 16 hours or less, about 12 hour or less, about 8 hours or less, about 6 hours or less, about 3 hours or less, about 2 hours or less, about 1 hour or less, about 30 minutes or less, or about 15 minutes or less after loss of one or more of respiratory activity, loss of heartbeat, or loss of brain activity).

In some embodiments, the tissue is washed before, after, or at the time of onset of ischemia in the tissue. In some embodiments, washing of the tissue is initiated about 1 minute or longer after the onset of ischemia of the tissue (for example, about 3 minutes or longer, about 5 minutes or longer, about 15 minutes or longer, about 30 minutes or longer, about 1 hour or longer, about 2 hours or longer, about 3 hours or longer, about 6 hours or longer, or about 8 hours or longer after the onset of ischemia of the tissue). In some embodiments, washing of the tissue is initiated about 24 hours or less after the onset of ischemia of the tissue (such as about 16 hours or less, about 12 hour or less, about 8 hours or less, about 6 hours or less, about 3 hours or less, about 2 hours or less, about 1 hour or less, about 30 minutes or less, or about 15 minutes or less after the onset of ischemia of the tissue).

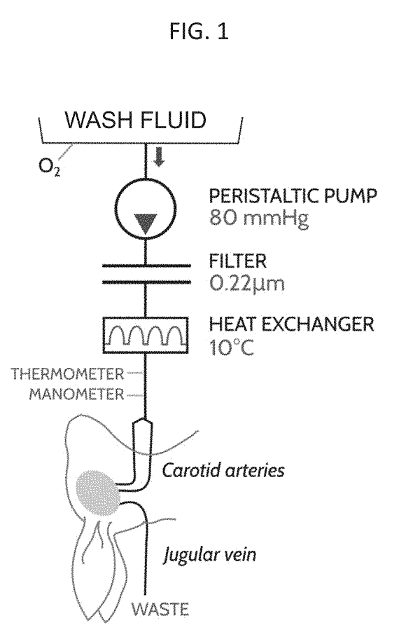

FIG. 1 illustrates an exemplary setup to perfuse the tissue with a wash fluid. The wash fluid is pumped by a peristaltic pump into the tissue through one or more arteries (e.g. the carotid arteries), and fluid is drained from a vein (e.g., the jugular vein). The wash fluid is held in a container, and a pump (such as a peristaltic pump) pumps the wash fluid into the tissue at a desired pressure (e.g., about 80 mmHg). Prior to entering the subject, the fluid passes through a sterile filter and a heat exchanger to sterilize and cool the wash fluid. A thermometer and a manometer can also be included in the setup to monitor temperature and pressure of the wash fluid perfused into the tissue.

In some embodiments, perfusion of the tissue with the wash fluid is monitored for distribution. In some embodiments, the wash fluid comprises a dye (such as a radiopaque dye) or contrast agent. Exemplary contrast agents or radiopaque dyes include, but are not limited to, iodide salts (such as potassium iodide or sodium iodide), barium salts (such as barium chloride), chelate complex with heavy metals (such as lead or gold), or gadolinium. In some embodiments, the concentration of the dye in the wash fluid is about 0.1 g/L or higher (such as about 0.2 g/L or higher, about 0.5 g/L or higher, about 1 g/L or higher, about 2 g/L or higher, about 5 g/L or higher, or about 10 g/L or higher). In some embodiments, the concentration of the dye in the wash fluid is about 20 g/L or lower (such as about 10 g/L or lower, about 5 g/L or lower, about 2 g/L or lower, about 1 g/L or lower, about 0.5 g/L or lower, or about 0.2 g/L or lower). In some embodiments the distribution is monitored by CT, microCT, X-Ray, or MRI.

### Fixation Fluid and Fixing the Tissue

After the tissue has been washed, a fixation fluid is perfused into the tissue. The fixation fluid fixes the tissue by forming crosslinks within the tissue. The crosslinks stabilize the fine structure of the tissue to allow for analysis of the preserved tissue. Once the tissue is preserved by the fixation fluid, impact to the tissue from the cryoprotection fluid is minimized. The fixation fluid includes a fixing agent, such as an aldehyde, in an aqueous solution. Exemplary aldehydes to include in the fixing fluid include formaldehyde and glutaraldehyde.

In some embodiments, the fixation fluid includes a buffer. Exemplary buffers include a phosphate buffer (such as sodium phosphate or potassium phosphate), sodium carbonate, or HEPES. In some embodiments, the fixation fluid includes one or more salts, such as sodium chloride, potassium chloride, magnesium chloride, or calcium chloride. In some embodiments, the pH of the fixation fluid is between about 7 and about 8 (such as about 7.2 to about 7.8, or about 7.4 to about 7.6).

Aldehyde, such as glutaraldehyde or formaldehyde can be included in the fixation fluid. In some embodiments, the fixation fluid comprises about 1% (by weight) aldehyde or more (such about 1.5% or more, about 2% or more, about 2.5% or more, or about 3% or more). In some embodiments, the fixation fluid comprises about 6% or less aldehyde (such as about 5.5% or less, about 5% or less, about 4.5% or less, about 4% or less, about 3.5% or less, about 3% or less, about 2.5% or less, or about 2% or less aldehyde). In some embodiments, the fixation fluid comprises about 1% (by weight) glutaraldehyde or more (such about 1.5% or more, about 2% or more, about 2.5% or more, or about 3% or more). In some embodiments, the fixation fluid comprises about 6% or less glutaraldehyde (such as about 5.5% or less, about 5% or less, about 4.5% or less, about 4% or less, about 3.5% or less, about 3% or less, about 2.5% or less, or about 2% or less aldehyde). In some embodiments, the fixation fluid comprises about 1% (by weight) formaldehyde or more (such about 1.5% or more, about 2% or more, about 2.5% or more, or about 3% or more). In some embodiments, the fixation fluid comprises about 6% or less formaldehyde (such as about 5.5% or less, about 5% or less, about 4.5% or less, about 4% or less, about 3.5% or less, about 3% or less, about 2.5% or less, or about 2% or less aldehyde).

In some embodiments, the fixation fluid includes an ion channel blocker or an ion receptor blocker. Exemplary ion channel blockers or ion receptor blockers include, but are not limited to, a conotoxin (such as α-conotoxin, γ-conotoxin, κ-conotoxin, ω-conotoxin, or μ-conotoxin, which act to block acetylcholine channels, sodium channels, potassium channels, and calcium channels), tetrodotoxin (which acts to block sodium channels), a conantokin (such as conantokin-G, conantokin-T, conantokin-R, conantokin-P, or conantokin-E, which inhibit the N-methyl-D-aspartate receptor (NMDAR)), curare (which blocks acetylcholine channels), or barium (which blocks potassium channels). In some embodiments, the ion channel blocker or the ion receptor blocker is included in the fixation fluid at a concentration of about 50 ng/L or more (such as about 100 ng/L or more, about 250 ng/L or more, about 500 ng/L or more, about 1 μg/L or more, about 2.5 μg/L or more, about 5 μg/L or more, about 10 μg/L or more, about 25 μg/L or more, about 50 μg/L or more, about 100 μg/L or more, about 250 μg/L or more, about 500 μg/L or more, about 1 mg/L or more, about 2.5 mg/L or more, about 5 mg/L or more, about 10 mg/L or more, about 25 mg/L or more, about 50 mg/L or more, about 100 mg/L or more, or about 250 mg/L or more). In some embodiments, the ion channel blocker or the ion receptor blocker is include in the fixation fluid at a concentration of about 500 mg/L or less (such as about 250 mg/L or less, about 100 mg/L or less, about 50 mg/L or less, about 25 mg/L or less, about 10 mg/L or less, about 5 mg/L or less, about 2.5 mg/L or less, about 1 mg/L or less, about 500 μg/L or less, about 250 μg/L or less, about 100 μg/L or less, about 50 μg/L or less, about 25 μg/L or less, about 10 μg/L or less, about 5 μg/L or less, about 2.5 μg/L or less, about 1 μg/L or less, about 500 ng/L or less, about 250 ng/L or less, or about 100 ng/L or less). In some embodiments, the fixation fluid includes a combination of ion channel blockers and/or ion receptor blockers. Solely by way of example, in some embodiments the fixation fluid include a conotoxin (such as κ-conotoxin) at a concentration of about 50 ng/L to about 5 μg/L, tetrodotoxin at a concentration of about 500 ng/L to about 25 mg/L, conantokin-G at a concentration of about 250 ng/L to about 10 mg/L, and curare at a concentration of about 5 mg/L to about 50 mg/L.

In some embodiments, the fixation fluid includes a calcium chelator. Exemplary calcium chelators include, but are not limited to, ethylenediaminetetraacetic acid (EDTA), egtazic acid (EGTA), 1,2-bis(o-aminophenoxy)ethane-N,N,N′,N′-tetraacetic acid (BAPTA), or citrate. In some embodiments, the calcium chelator is included in the fixation fluid at a concentration of about 0.1 g/L or higher (such as about 0.25 g/L or higher, about 0.5 g/L or higher, about 1 g/L or higher, about 2 g/L or higher, about 3 g/L or higher, or about 4 g/L or higher). In some embodiments, the calcium chelator is included in the fixation fluid at a concentration of about 5 g/L or less (such as about 4 g/L or less, about 3 g/L or less, about 2 g/L or less, about 1 g/L or less, about 0.5 g/L or less, or about 0.25 g/L or less).

In some embodiments, the fixation fluid includes a respiratory poison. Exemplary respiratory poisons include azide (such as sodium azide) or cyanide (such as sodium cyanide). In some embodiments, the concentration of the respiratory poison in the fixation fluid is about 0.1 g/L or higher (such as about 0.2 g/L or higher, about 0.5 g/L or higher, about 1 g/L or higher, or about 1.5 g/L or higher). In some embodiments, the concentration of the respiratory poison in the fixation fluid is about 2 g/L or lower (such as about 1.5 g/L or lower, about 1 g/L or lower, about 0.5 g/L or lower, or about 0.2 g/L or lower).

In some embodiments a synaptic poison (such as a SNARE inhibitor) is included in the fixation fluid. Exemplary synaptic poisons include botulinum toxin or tetanus toxin. In some embodiments, both botulinum toxin and tetanus toxin are included in the fixation fluid. In some embodiments, the concentration of the synaptic poison in the fixation fluid is about 0.1 ng/L or more (such as about 0.2 ng/L or more, about 0.5 ng/L or more, about 1 ng/L or more, about 2 ng/L or more, about 5 ng/L or more, about 10 ng/L or more, about 25 ng/L or more, about 50 ng/L or more, about 100 ng/L or more, or about 150 ng/L or more). In some embodiments, the concentration of the synaptic poison in the fixation fluid is about 200 ng/L or less (such as about 150 ng/L or less, about 100 ng/L or less, about 50 ng/L or less, about 25 ng/L or less, about 10 ng/L or less, about 5 ng/L or less, about 2 ng/L or less, about 1 ng/L or less, about 0.5 ng/L or less, or about 0.2 ng/L or less).

In some embodiments, the fixation fluid includes a vasodilator. Exemplary vasodilators include sodium nitrite, nitroglycerin, isosorbide mononitrate, isosorbide dinitrate, itramin tosilate, pentaerithrityl tetranitrate, propatylnitrate, tenitramine, trolnitrate, or molsidomine. In some embodiments, the vasodilator is included in the fixation fluid at a concentration of about 0.1 g/L or more (such as about 0.2 g/L or more, about 0.5 g/L or more, or about 0.7 g/L or more). In some embodiments, the vasodilator is included in the fixation fluid at a concentration of about 1 g/L or less (such as about 0.7 g/L or less, about 0.5 g/L or less, or about 0.2 g/L or less).

In some embodiments, an ionic surfactant (such as sodium dodecyl sulfate (SDS) or sodium dodecyl benzenesulfonate (SDBS)) is included in the fixation fluid. The ionic surfactant can be used to prevent tissue shrinkage during the cryoprotection process. In some embodiments, the ionic surfactant is included in the fixation fluid at a concentration of about 0.001% w/v or higher (such as about 0.002% w/v or higher, about 0.005% w/v or higher, or about 0.01% w/v or higher). In some embodiments, the ionic surfactant is included in the fixation fluid at a concentration of about 0.05% w/v or lower (such as about 0.04% w/v or lower, about 0.02% w/v or lower, or about 0.01% w/v or lower).

In some embodiments, perfusion of the tissue with the fixation fluid is dynamically monitored for distribution. In some embodiments, the fixation fluid comprises a dye (such as a radiopaque dye) or contrast agent. Exemplary contrast agents or radiopaque dyes include, but are not limited to, iodide salts (such as potassium iodide or sodium iodide), barium salts (such as barium chloride), chelate complex with heavy metals (such as lead or gold), or gadolinium. In some embodiments, the concentration of the dye in the fixation fluid is about 0.1 g/L or higher (such as about 0.2 g/L or higher, about 0.5 g/L or higher, about 1 g/L or higher, about 2 g/L or higher, about 5 g/L or higher, or about 10 g/L or higher). In some embodiments, the concentration of the dye in the fixation fluid is about 20 g/L or lower (such as about 10 g/L or lower, about 5 g/L or lower, about 2 g/L or lower, about 1 g/L or lower, about 0.5 g/L or lower, or about 0.2 g/L or lower). In some embodiments, distribution of the fixation fluid is monitored by CT, microCT, X-Ray, or MRI.

In some embodiments, the fixation fluid is perfused into the tissue in two or more stages. A first stage fixation fluid perfused into the tissue may include additives (or a different concentration of additives) that are omitted from the second stage or later stage fixation fluid. For example, in some embodiments, the first stage fixation fluid can include the ion channel blocker or ion receptor blocker, the respiratory poison, the calcium chelator, the synaptic poison, and/or the vasodilator, and the second or later stage fixation fluid can omit any one or more of these compounds. All stages of the fixation fluid should include the aldehyde, although in some embodiments the concentration of the aldehyde may differ. Transition of perfusion from any given stage to a later stage can be discrete (that is, the perfusion of the earlier stage fixation fluid into the tissue ends at the start of perfusing the later stage fixation fluid into the tissue), or can be as a gradient (for example, simultaneously decreasing the relative amount of the earlier stage fixation fluid and increasing the relative amount of the later stage fixation fluid until perfusion of the tissue with the earlier stage fixation fluid has ended).

In some embodiments, the fixation fluid is perfused into the tissue at a pressure of about 60 mmHg to about 140 mmHg (such as about 60 mmHg to about 80 mmHg, about 80 mmHg to about 100 mmHg, about 100 mmHg to about 120 mmHg, or about 120 mmHg to about 140 mmHg).

In some embodiments the fixation fluid is filtered prior to perfusion. In some embodiments, the fixation fluid is sterile filtered prior to perfusion. In some embodiments, the fixation fluid is filtered with a filter having an average pore size of about 0.5 μm or smaller, such as about 0.22 μm or smaller.

### Cryoprotection Fluid and Cryoprotecting the Tissue

Once the tissue has been fixed by perfusing the tissue with the fixation fluid, the tissue is cryoprotected by perfusing the tissue with a cryoprotection fluid. The cryoprotection fluid includes a vitrification agent, which suppresses the formation of ice crystals upon cooling (or vitrifying) the tissue to sub-zero temperatures. Ice crystals should be minimized to avoid disruption of the microanatomy of the tissue during cooling and storage. In some embodiments, the cryoprotectant inhibits the formation of any ice crystals upon cooling (or vitrifying) the tissue.

Exemplary vitrification agents include one or more of glycerol, dimethyl sulfoxide (DMSO), ethylene glycol and/or polyethylene glycol (PEG). In some embodiments, the polyethylene glycol has a molecular weight of about 200 to about 10,000 Daltons (Da) (such as about 200 Da to about 400 Da, about 400 Da to about 1000 Da, about 1000 Da to about 2000 Da, about 2000 Da to about 4000 Da, or about 4000 Da to about 10,000 Da). In some embodiments, the polyethylene glycol has a molecular weight of about 200 Da or higher (such as about 400 Da or higher, about 1000 Da or higher, about 2000 Da or higher, or about 4000 Da or higher). In some embodiments, the polyethylene glycol has a molecular weight of about 10,000 Da or lower (such as about 4000 Da or lower, about 2000 Da or lower, about 1000 Da or lower, or about 400 Da or lower). In some embodiments, the cryoprotection fluid includes two or more different vitrification agents. By way of example, in some embodiments the cryoprotection fluid includes ethylene glycol, PEG 200, and PEG 400. In some embodiments, the concentration of any one or more of the vitrification agents (such as the ethylene glycol or polyethylene glycol) or the total concentration of the plurality of vitrification agents in the cryoprotection fluid is about 0.1% or higher (such as about 0.5% or higher, about 1% or higher, about 5% or higher, about 10% or higher, about 30% or higher, about 40% or higher, about 50% or higher, or about 60% or higher). In some embodiments, the concentration of any one or more of the vitrification agents (such as the ethylene glycol or polyethylene glycol) or the total concentration of the plurality of vitrification agents in the cryoprotection fluid is about 70% or lower (such as about 65% or lower, about 60% or lower, about 50% or lower, about 40% or lower, about 30% or lower, about 20% or lower, about 10% or lower, about 5% or lower, about 1% or lower, or about 0.5% or lower). By way of example, in some embodiments the cryoprotection fluid includes ethylene glycol at a concentration of about 10% to about 30% (such as about 20%), PEG 200 at a concentration of about 20% to about 40% (such as about 30%), and PEG 400 at a concentration of about 10% to about 30% (such as about 20%).

The one or more vitrification agents and/or concentrations of the one or more vitrification agents can be selected based on the desired vitrification temperature (also referred to as the glass transition temperature, or T_{g}) of the cryoprotection fluid. For example, PEG 200 has a vitrification temperature of about 0° C., and can be used to adjust the vitrification temperature of the cryoprotection fluid. In some embodiments, the cryoprotection fluid has a vitrification temperature of about −195° C. to about +50° C. (such as between about −195° C. to about −160° C., about −160° C. to about −120° C., about −120° C. to about −80° C., about −80° C. to about −40° C., about −40° C. to about 0° C., about 0° C. to about +25° C., or about +25° C. to about +50° C.). In some embodiments, the cryoprotection fluid has a vitrification temperature of about −195° C. or higher (such as about −160° C. or higher, about −120° C. or higher, about −80° C. or higher, about −40° C. or higher, about 0° C. or higher, or about +25° C. or higher). In some embodiments, the cryoprotection fluid has a vitrification temperature of about +50° C. or lower (such as about +25° C. or lower, about 0° C. or lower, about −40° C. or lower, about −80° C. or lower, about −120° C. or lower, or about −160° C. or lower).

In some embodiments, the cryoprotection fluid includes a buffer. Exemplary buffers include a phosphate buffer (such as sodium phosphate or potassium phosphate), sodium carbonate, or HEPES. In some embodiments, the cryoprotection fluid includes one or more salts, such as sodium chloride, potassium chloride, magnesium chloride, or calcium chloride. In some embodiments, the pH of the cryoprotection fluid is between about 7 and about 8 (such as about 7.2 to about 7.8, or about 7.4 to about 7.6).

In some embodiments, an aldehyde, such as glutaraldehyde or formaldehyde is included in the cryoprotection fluid. In some embodiments, the cryoprotection fluid comprises about 1% (by weight) aldehyde or more (such about 1.5% or more, about 2% or more, about 2.5% or more, or about 3% or more). In some embodiments, the cryoprotection fluid comprises about 6% or less aldehyde (such as about 5.5% or less, about 5% or less, about 4.5% or less, about 4% or less, about 3.5% or less, about 3% or less, about 2.5% or less, or about 2% or less aldehyde). In some embodiments, the cryoprotection fluid comprises about 1% (by weight) glutaraldehyde or more (such about 1.5% or more, about 2% or more, about 2.5% or more, or about 3% or more). In some embodiments, the cryoprotection fluid comprises about 6% or less glutaraldehyde (such as about 5.5% or less, about 5% or less, about 4.5% or less, about 4% or less, about 3.5% or less, about 3% or less, about 2.5% or less, or about 2% or less aldehyde). In some embodiments, the cryoprotection fluid comprises about 1% (by weight) formaldehyde or more (such about 1.5% or more, about 2% or more, about 2.5% or more, or about 3% or more). In some embodiments, the cryoprotection fluid comprises about 6% or less formaldehyde (such as about 5.5% or less, about 5% or less, about 4.5% or less, about 4% or less, about 3.5% or less, about 3% or less, about 2.5% or less, or about 2% or less aldehyde).

In some embodiments, the cryoprotection fluid includes an ion channel blocker or an ion receptor blocker. Exemplary ion channel blockers or ion receptor blockers include, but are not limited to, a conotoxin (such as α-conotoxin, γ-conotoxin, κ-conotoxin, ω-conotoxin, or μ-conotoxin, which act to block acetylcholine channels, sodium channels, potassium channels, and calcium channels), tetrodotoxin (which acts to block sodium channels), a conantokin (such as conantokin-G, conantokin-T, conantokin-R, conantokin-P, or conantokin-E, which inhibit the N-methyl-D-aspartate receptor (NMDAR)), curare (which blocks acetylcholine channels), or barium (which blocks potassium channels). In some embodiments, the ion channel blocker or the ion receptor blocker is included in the cryoprotection fluid at a concentration of about 50 ng/L or more (such as about 100 ng/L or more, about 250 ng/L or more, about 500 ng/L or more, about 1 μg/L or more, about 2.5 μg/L or more, about 5 μg/L or more, about 10 μg/L or more, about 25 μg/L or more, about 50 μg/L or more, about 100 μg/L or more, about 250 μg/L or more, about 500 μg/L or more, about 1 mg/L or more, about 2.5 mg/L or more, about 5 mg/L or more, about 10 mg/L or more, about 25 mg/L or more, about 50 mg/L or more, about 100 mg/L or more, or about 250 mg/L or more). In some embodiments, the ion channel blocker or the ion receptor blocker is include in the cryoprotection fluid at a concentration of about 500 mg/L or less (such as about 250 mg/L or less, about 100 mg/L or less, about 50 mg/L or less, about 25 mg/L or less, about 10 mg/L or less, about 5 mg/L or less, about 2.5 mg/L or less, about 1 mg/L or less, about 500 μg/L or less, about 250 μg/L or less, about 100 μg/L or less, about 50 μg/L or less, about 25 μg/L or less, about 10 μg/L or less, about 5 μg/L or less, about 2.5 μg/L or less, about 1 μg/L or less, about 500 ng/L or less, about 250 ng/L or less, or about 100 ng/L or less). In some embodiments, the cryoprotection fluid includes a combination of ion channel blockers and/or ion receptor blockers. Solely by way of example, in some embodiments the cryoprotection fluid include a conotoxin (such as κ-conotoxin) at a concentration of about 50 ng/L to about 5 μg/L, tetrodotoxin at a concentration of about 500 ng/L to about 25 mg/L, conantokin-G at a concentration of about 250 ng/L to about 10 mg/L, and curare at a concentration of about 5 mg/L to about 50 mg/L.

In some embodiments, the cryoprotection fluid includes a calcium chelator. Exemplary calcium chelators include, but are not limited to, ethylenediaminetetraacetic acid (EDTA), egtazic acid (EGTA), 1,2-bis(o-aminophenoxy)ethane-N,N,N′,N′-tetraacetic acid (BAPTA), or citrate. In some embodiments, the calcium chelator is included in the fixation fluid at a concentration of about 0.1 g/L or higher (such as about 0.25 g/L or higher, about 0.5 g/L or higher, about 1 g/L or higher, about 2 g/L or higher, about 3 g/L or higher, or about 4 g/L or higher). In some embodiments, the calcium chelator is included in the fixation fluid at a concentration of about 5 g/L or less (such as about 4 g/L or less, about 3 g/L or less, about 2 g/L or less, about 1 g/L or less, about 0.5 g/L or less, or about 0.25 g/L or less).

In some embodiments, the cryoprotection fluid includes a respiratory poison. Exemplary respiratory poisons include azide (such as sodium azide) or cyanide (such as sodium cyanide). In some embodiments, the concentration of the respiratory poison in the cryoprotection fluid is about 0.1 g/L or higher (such as about 0.2 g/L or higher, about 0.5 g/L or higher, about 1 g/L or higher, or about 1.5 g/L or higher). In some embodiments, the concentration of the respiratory poison in the cryoprotection fluid is about 2 g/L or lower (such as about 1.5 g/L or lower, about 1 g/L or lower, about 0.5 g/L or lower, or about 0.2 g/L or lower).

In some embodiments a synaptic poison (such as a SNARE inhibitor) is included in the cryoprotection fluid. Exemplary synaptic poisons include botulinum toxin or tetanus toxin. In some embodiments, both botulinum toxin and tetanus toxin are included in the cryoprotection fluid. In some embodiments, the concentration of the synaptic poison in the cryoprotection fluid is about 0.1 ng/L or more (such as about 0.2 ng/L or more, about 0.5 ng/L or more, about 1 ng/L or more, about 2 ng/L or more, about 5 ng/L or more, about 10 ng/L or more, about 25 ng/L or more, about 50 ng/L or more, about 100 ng/L or more, or about 150 ng/L or more). In some embodiments, the concentration of the synaptic poison in the cryoprotection fluid is about 200 ng/L or less (such as about 150 ng/L or less, about 100 ng/L or less, about 50 ng/L or less, about 25 ng/L or less, about 10 ng/L or less, about 5 ng/L or less, about 2 ng/L or less, about 1 ng/L or less, about 0.5 ng/L or less, or about 0.2 ng/L or less).

In some embodiments, the cryoprotection fluid includes a vasodilator. Exemplary vasodilators include sodium nitrite, nitroglycerin, isosorbide mononitrate, isosorbide dinitrate, itramin tosilate, pentaerithrityl tetranitrate, propatylnitrate, tenitramine, trolnitrate, or molsidomine. In some embodiments, the vasodilator is included in the cryoprotection fluid at a concentration of about 0.1 g/L or more (such as about 0.2 g/L or more, about 0.5 g/L or more, or about 0.7 g/L or more). In some embodiments, the vasodilator is included in the cryoprotection fluid at a concentration of about 1 g/L or less (such as about 0.7 g/L or less, about 0.5 g/L or less, or about 0.2 g/L or less).

In some embodiments, perfusion of the tissue with the cryoprotection fluid is dynamically monitored for distribution. In some embodiments, the cryoprotection fluid comprises a dye (such as a radiopaque dye) or contrast agent. Exemplary contrast agents or radiopaque dyes include, but are not limited to, iodide salts (such as potassium iodide or sodium iodide), barium salts (such as barium chloride), chelate complex with heavy metals (such as lead or gold), or gadolinium. In some embodiments, the concentration of the dye in the cryoprotection fluid is about 0.1 g/L or higher (such as about 0.2 g/L or higher, about 0.5 g/L or higher, about 1 g/L or higher, about 2 g/L or higher, about 5 g/L or higher, or about 10 g/L or higher). In some embodiments, the concentration of the dye in the cryoprotection fluid is about 20 g/L or lower (such as about 10 g/L or lower, about 5 g/L or lower, about 2 g/L or lower, about 1 g/L or lower, about 0.5 g/L or lower, or about 0.2 g/L or lower). In some embodiments, distribution of the cryoprotection fluid is monitored by CT, microCT, X-Ray, or MRI.

In some embodiments, the cryoprotection fluid is perfused into the tissue at a pressure of about 60 mmHg to about 140 mmHg (such as about 60 mmHg to about 80 mmHg, about 80 mmHg to about 100 mmHg, about 100 mmHg to about 120 mmHg, or about 120 mmHg to about 140 mmHg).

In some embodiments the cryoprotection fluid is filtered prior to perfusion. In some embodiments, the cryoprotection fluid is sterile filtered prior to perfusion. In some embodiments, the cryoprotection fluid is filtered with a filter having an average pore size of about 0.5 μm or smaller, such as about 0.22 μm or smaller.

In some embodiments, the cryoprotection fluid is perfused into the tissue as a discrete step (that is, after perfusion of the tissue with the fixation fluid has ended). In some embodiments, the cryoprotection fluid is perfused into the tissue as a gradient against the fixation fluid. That is, as the relative amount of fixation fluid perfused into the tissue is decreased, the relative amount of cryoprotection fluid perfused into the tissue is increased until perfusion of the fixation fluid into the tissue has stopped.

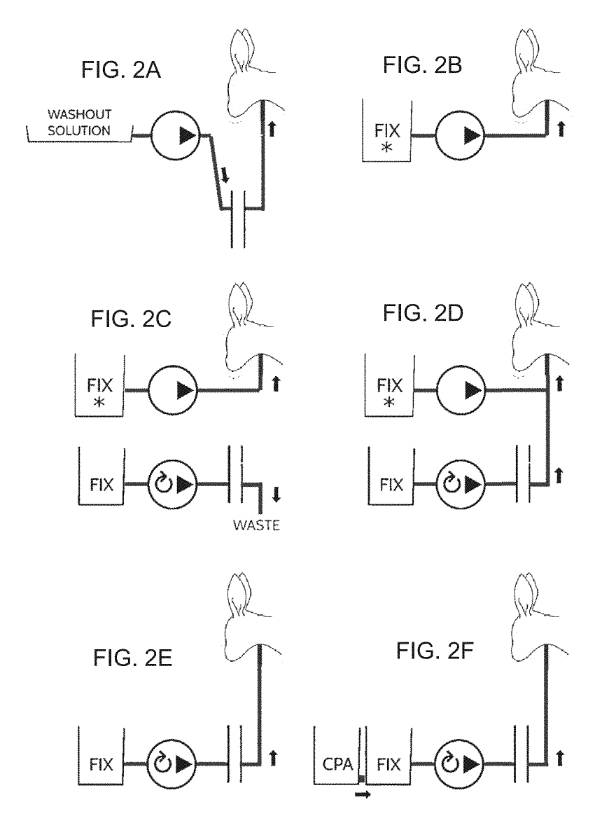

FIG. 2A-F illustrates an exemplary method of preserving a tissue (such as a brain) in a subject. FIG. 2A illustrates the tissue being perfused by a wash fluid. The wash fluid is pumped through a filter and into arteries leading into the tissue. After the tissue has been washed, a first stage fixation fluid is pumped through the arteries to perfuse the tissue, shown in FIG. 2B. A second stage fixation fluid is primed through the system (as shown in FIG. 2C), and is pumped into the tissue along with the first stage fixation fluid, as shown in in FIG. 2D. The second stage fixation fluid is perfused into the tissue as a gradient to replace the first stage fixation fluid, as the pump connected to the first stage fixation fluid slows as the pump connected to the second stage fixation fluid is sped up. The tissue can then be perfused by the second stage fixation fluid (and without the first stage fixation fluid), as shown in FIG. 2E. The cryoprotection fluid can then be perfused into the tissue as a gradient against the second stage fixation fluid, as shown in FIG. 2F.

### Vitrification, Storage, Thawing, and Analysis of the Tissue

Once the cryoprotection fluid has been perfused into the tissue, the tissue can be vitrified. The tissue is cooled to a temperature below the vitrification temperature of the cryoprotection fluid, for example by placing the tissue in a cold storage (for example, a mechanical freezer, a liquid nitrogen vapor freezer, an isothermal liquid nitrogen freezer, or immersing the tissue in liquid nitrogen). An exemplary cold storage system is a Controllable Isothermal Vapor Storage (CIVS) device (21st Century Medicine, Inc.). In some embodiments, the temperature of the tissue is vitrified to a temperature of about −80° C. or less (such as about −100° C. or less, about −120° C. or less, about −140° C. or less, or about −160° C. or less). Temperature of the tissue can be monitored by inserting a temperature probe in or adjacent to the tissue during vitrification. In some embodiments, the tissue is removed from the subject after the tissue has been perfused with the cryoprotection fluid and before the tissue is vitrified.

In some embodiments, the tissue is biopsied prior to vitrification. The tissue can be biopsied, for example, at locations within the tissue with low perfusion distribution, for example as monitored by imaging the tissue with the perfusion fluid containing the dye or contrast agent. The biopsied sample can be analyzed to provide a lower boundary of tissue quality to compare to the tissue after vitrification.

After vitrification of the tissue, the tissue can be stored at the depressed temperature for long term. In some embodiments, the vitrified tissue is stored for about 24 hours or longer (such as about 48 hours or longer, about 72 hours or longer, about 96 hours or longer, about 7 days or longer, about 14 days or longer, about a month or longer, about 2 months or longer, about 3 months or longer, about 6 months or longer, or about a year or longer).

The vitrified tissues can be removed from cold storage and thawed for analysis. Thawing the vitrified tissue can include removing the tissue from cold storage and allowing the tissue to acclimate to room temperature or any other desired temperature above the vitrification temperature of the cryopreservation fluid. In some embodiments, the vitrified tissue is submerged in a fluid, such as cryoprotection fluid or saline, during the thawing process.

The thawed, preserved tissue can be prepared for analysis. In some embodiments, the cryoprotection fluid is removed from the preserved tissue prior to further analysis. In some embodiments, the tissue is sliced to prepare the tissue for analysis. In some embodiments, the tissue is sliced prior to removing the cryoprotection fluid, and in some embodiments the cryoprotection fluid is removed prior to slicing the tissue.

In some embodiments, the cryoprotection fluid is removed by perfusing the tissue with a rinse fluid (for example, the fixing fluid (which may be a later stage fixing fluid), a buffered saline, a cacodylate buffer solution, or any embodiment of the wash fluid described herein), which is optionally perfused into the tissue as a gradient against perfused cryoprotection fluid. In some embodiments, the pH of the rinse fluid is between about 7 and about 8 (such as about 7.2 to about 7.8, or about 7.4 to about 7.6). For example, the thawed tissue can be initially perfused with the cryoprotection fluid, and the relative portion of cryoprotection fluid perfused into the thawed tissue can be decreased as the relative portion of the rinse fluid perfused into the thawed tissue is increased. Once the gradient is completed (that is, cryoprotection fluid is no longer being perfused into the tissue), a volume of the fixing fluid can continue to be perfused into the thawed tissue. In some embodiments, the rinse fluid is perfused into the thawed tissue at a pressure of about 60 mmHg to about 140 mmHg (such as about 60 mmHg to about 80 mmHg, about 80 mmHg to about 100 mmHg, about 100 mmHg to about 120 mmHg, or about 120 mmHg to about 140 mmHg). In some embodiments, the tissue is sliced for analysis after the cryoprotection fluid has been removed from the tissue. In some embodiments, the tissue is embedded in agar prior to slicing the tissue. The sliced tissue can be stored in storage buffer, such as the rinse buffer, a buffered saline, or a cacodylate buffer.

In some embodiments, the cryoprotection fluid is removed by diffusion. To facilitate diffusion of the cryoprotection fluid from the tissue, in some embodiments the tissue is sliced prior to diffusion. In some embodiments, the tissue is embedded in agar prior to slicing the tissue. The agar can include the vitrification agent in the cryoprotection fluid, which is preferable at the same concentration as in the cryoprotection fluid. The tissue (which may be sliced) is submerged in cryoprotection fluid, and the cryoprotection fluid is removed by dilution of the cryoprotection fluid with a storage buffer (such as the fixation fluid, buffered saline, or a cacodylate buffer). The cryoprotection fluid can be diluted over a period of time (for example, 50% replacement with the storage buffer every 5 to 15 minutes). The cryoprotection fluid can be considered removed when the concentration of the cryoprotection fluid is about 5% or less (such as about 4% or less, about 3% or less, about 2% or less, or about 1% or less).

In some embodiments, the preserved tissue is analyzed, for example by imaging the tissue or performing a microanatomical analysis of the tissue, or performing bulk tissue analysis such as by differential scanning calorimetry, western blot, or other laboratory assays. The tissue imaging can be performed, for example, using a light microscope, electron microscopy (e.g., scanning electron microscopy), focused ion beam microscopy, expansion microscopy, or fluorescence in situ hybridization (FISH) microscopy (or FISH expansion microscopy).

FISH microscopy can include staining the tissue with fluorescently labeled probes, for example oligonucleotides (such as RNA or DNA oligonucleotides) or antibodies. In some embodiments, the fluorescently labeled probes are perfused into the tissue to stain the tissue. The oligonucleotide or antibodies can bind to a target nucleic acid or protein in the tissue to determine the location of the targeted nucleic acid or protein.

In some embodiments, the tissue is stained for electron microscopy or expansion microscopy prior to analysis, for example using potassium ferrocyanide and osmium tetroxide. Other exemplary stains include ammonium molybdate, uranyl acetate, uranyl formate, phosphotungstic acid, and auroglucothionate. In some embodiments, the stain includes formamide (for example, about 1 M to about 3 M, such as about 2 M to about 3 M, or about 2.5 M formamide), which can be used to better penetrate the stain into the tissue. In some embodiments, the stain is perfused through the tissue.

In some embodiments, the tissue (such as one or more tissue slices) is embedded in plastic for analysis, for example for imaging by electron microscopy

In some embodiments, the tissue is analyzed without slicing the tissue (for example, after removing the cryoprotection fluid from the tissue by perfusing the tissue with the rinse fluid). Techniques for analyzing whole tissue, such as whole brains, are known in the art. See, for example, Mikula et al., High-resolution whole-brain staining for electron microscopic circuit reconstruction, Nat. Methods, vol. 12, pp. 541-546 (2015), describing a brain-wide reduced osmium staining with pyrogallol-mediated amplification (BROPA) method. Other methods include the CLARITY method, described in Chung et al., Structural and molecular interrogation of intact biological systems, Nature, vol. 497, pp. 332-337 (2013), and expansion microscopy, described in Chen et al., Expansion microscopy, Science vol. 347, pp. 543-548 (2015). Expansion microscopy allows for expanding the size of the tissue (for example from about 10 times to about 20 times the original size), and imaging the tissue to allow for high resolution of the tissue.

### Kits

In one aspect, there is provided a kit comprising a wash fluid, a fixation fluid, and a cryoprotection fluid as described herein. The wash fluid, the fixation fluid, and the cryoprotection fluid can be included in the kit in a concentrated form, which can be diluted, for example, using water. In some embodiments, the wash fluid, the fixation fluid, and the cryoprotection fluid are included at the operable concentrations. The fluids (or concentrates) can be contained within a suitable container such as vials, bottles, jars, flexible packaging (e.g., sealed Mylar or plastic bags), and the like. In some embodiments, the kits include instructions for use. In some embodiments, the instructions for use include instructions for preserving tissue according to any of the methods described herein.

### EXEMPLARY EMBODIMENTS

The following embodiments are exemplary and are not intended to limit the scope of the invention described herein.

### Embodiment 1

A method of preserving a tissue of a subject, comprising

washing the tissue by perfusing the tissue with a wash fluid comprising an aqueous solution;

fixing the tissue by perfusing the tissue with a fixation fluid comprising an aldehyde; and

cryoprotecting the tissue by perfusing the tissue with a cryoprotection fluid comprising a vitrification agent;

the wash fluid, the fixing fluid, or the cryoprotection fluid comprising a dye or a contrast agent.

### Embodiment 2

A method of preserving a tissue of a subject, comprising

washing the tissue by perfusing the tissue with a wash fluid comprising an aqueous solution;

fixing the tissue by perfusing the tissue with a fixation fluid comprising an aldehyde; and

cryoprotecting the tissue by perfusing the tissue with a cryoprotection fluid comprising a vitrification agent, the cryoprotection fluid having a vitrification temperature of about −80° C. or higher.

### Embodiment 3

A method of preserving a tissue of a subject, comprising

washing the tissue by perfusing the tissue with a wash fluid comprising (1) an aqueous solution, and (2) any one or more of an ion channel blocker, a calcium chelator, a thrombolytic agent, an anti-platelet, a respiratory poison, or a synaptic poison;

fixing the tissue by perfusing the tissue with a fixation fluid comprising an aldehyde; and

cryoprotecting the tissue by perfusing the tissue with a cryoprotection fluid comprising a vitrification agent.

### Embodiment 4

A method of preserving a tissue of a subject, comprising

washing the tissue by perfusing the tissue with a wash fluid comprising an aqueous solution;

fixing the tissue by perfusing the tissue with a fixation fluid comprising an aldehyde; and

cryoprotecting the tissue by perfusing the tissue with a cryoprotection fluid comprising a vitrification agent;

wherein the washing is initiated after onset of ischemia in the tissue.

### Embodiment 5

The method of any one of embodiments 2-4, wherein the wash fluid, the fixation fluid, or the cryoprotection fluid comprises a dye or a contrast agent.

### Embodiment 6

The method of embodiment 1 or embodiment 5, wherein the wash fluid, the fixation fluid, or the cryoprotection fluid comprises a radiopaque dye.

### Embodiment 7

The method of any one of embodiments 1-6, further comprising monitoring by imaging a distribution of the wash fluid, the fixation fluid, or the cryoprotection fluid in the tissue.

### Embodiment 8

A method of preserving a tissue of a subject, comprising

washing the tissue by perfusing the tissue with a wash fluid comprising an aqueous solution;

fixing the tissue by perfusing the tissue with a fixation fluid comprising an aldehyde;

cryoprotecting the tissue by perfusing the tissue with a cryoprotection fluid comprising a vitrification agent; and

monitoring by imaging a distribution of the wash fluid, the fixation fluid, or the cryoprotection fluid in the tissue.

### Embodiment 9

The method of embodiment 7 or 8, wherein the monitoring is performed by computed tomography (CT), micro computed tomography (microCT), X-Ray, or MRI.

### Embodiment 10

The method of any one of embodiments 1-9, wherein perfusion of the tissue with the wash fluid, the fixation fluid, or the cryoprotection fluid is performed according to a perfusion schedule, wherein the perfusion schedule is modified based on the monitored distribution of the wash fluid, the fixation fluid, or the cryoprotection fluid.

### Embodiment 11

The method of any one of embodiments 1-10, further comprising vitrifying the tissue.

### Embodiment 12

The method of any one of embodiments 1-11, wherein the tissue is vitrified to a temperature of about −100° C. or colder.

### Embodiment 13

The method of embodiment 11 or embodiment 12, comprising storing the vitrified tissue for about 72 hours or longer.

### Embodiment 14

The method of any one of embodiments 11-13, comprising thawing the vitrified tissue.

### Embodiment 15

The method of any one of embodiments 1-14, comprising imaging at least a portion of the preserved tissue.

### Embodiment 16

The method of any one of embodiments 1-15, comprising characterizing at least a portion of the preserved tissue through a microanatomical analysis.

### Embodiment 17

The method of any one of embodiments 1-16, wherein at least a portion of the preserved tissue is imaged using electron microscopy, expansion microscopy, or fluorescence in situ hybridization (FISH) expansion microscopy.

### Embodiment 18

A method of analyzing a preserved tissue from a subject, comprising imaging or performing a microanatomical analysis on the preserved tissue, the tissue having been preserved by:

washing the tissue by perfusing the tissue with a wash fluid comprising an aqueous solution;

fixing the tissue by perfusing the tissue with a fixation fluid comprising an aldehyde;

cryoprotecting the tissue by perfusing the tissue with a cryoprotection fluid comprising a vitrification agent; and

monitoring a distribution of the wash fluid, the fixation fluid, or the cryoprotection fluid during the perfusing of the tissue.

### Embodiment 19

A method of analyzing a preserved tissue from a subject, comprising imaging or performing a microanatomical analysis on the preserved tissue, the tissue having been preserved by:

washing the tissue by perfusing the tissue with a wash fluid comprising an aqueous solution;

fixing the tissue by perfusing the tissue with a fixation fluid comprising an aldehyde; and

cryoprotecting the tissue by perfusing the tissue with a cryoprotection fluid comprising a vitrification agent, the cryoprotection fluid having a vitrification temperature of about −80° C. or higher.

### Embodiment 20

A method of analyzing a preserved tissue from a subject, comprising imaging or performing a microanatomical analysis on the preserved tissue, the tissue having been preserved by:

washing the tissue by perfusing the tissue with a wash fluid comprising (1) an aqueous solution, and (2) any one or more of an ion channel blocker, a calcium chelator, a thrombolytic agent, an anti-platelet, a respiratory poison, or a synaptic poison;

fixing the tissue by perfusing the tissue with a fixation fluid comprising an aldehyde; and

cryoprotecting the tissue by perfusing the tissue with a cryoprotection fluid comprising a vitrification agent.

### Embodiment 21

The method of embodiment 19 or 20, wherein a distribution of the wash fluid, the fixation fluid or the cryoprotection fluid in the tissue was monitored during perfusion of the tissue.

### Embodiment 22

The method of embodiment 18 or embodiment 21, wherein perfusion of the tissue was monitored using CT, microCT, X-Ray, or MRI.

### Embodiment 23

The method of any one of embodiments 18-22, comprising thawing the preserved tissue.

### Embodiment 24

The method of any one of embodiments 18-23, wherein imaging or performing the microanatomical analysis on the preserved tissue comprises imaging the preserved tissue using electron microscopy, expansion microscopy, or fluorescence in situ hybridization (FISH) microscopy.

### Embodiment 25

The method of any one of embodiments 16-24, wherein perfusion of the tissue with the wash fluid, the fixation fluid, or the cryoprotection fluid was performed according to a perfusion schedule, wherein the perfusion schedule was modified based on the distribution of the wash fluid, the fixation fluid, or the cryoprotection fluid during perfusion of the tissue.

### Embodiment 26

The method of any one of embodiments 1-25, wherein the cryoprotection fluid is perfused into the tissue as a gradient against the fixation fluid.

### Embodiment 27

The method any one of embodiments 1-26, wherein the wash fluid, the fixation fluid, or the cryoprotection fluid comprises an ion channel blocker or an ion receptor blocker.

### Embodiment 28

The method of any one of embodiments 1-27, wherein the wash fluid, the fixation fluid, or the cryoprotection fluid comprises a calcium chelator.

### Embodiment 29

The method of any one of embodiments 1-28, wherein the wash fluid, the fixation fluid, or the cryoprotection fluid comprises a respiratory poison.

### Embodiment 30

The method of any one of embodiments 1-29, wherein the wash fluid, the fixation fluid, or the cryoprotection fluid comprises a synaptic poison.

### Embodiment 31

The method of any one of embodiments 1-30, wherein the wash fluid, the fixation fluid, or the cryoprotection fluid comprises a vasodilator.

### Embodiment 32

The method of any one of embodiments 1-31, wherein the wash fluid, the fixation fluid, or the cryoprotection fluid comprises an oncotic agent.

### Embodiment 33

The method of any one of embodiments 1-32, wherein the wash fluid or the fixation fluid comprises an ionic surfactant.

### Embodiment 34

The method of any one of embodiments 1-33, wherein the wash fluid comprises an anesthetic.

### Embodiment 35

The method of any one of embodiments 1-34, wherein the wash fluid comprises a thrombolytic agent.

### Embodiment 36

The method of any one of embodiments 1-35, wherein the wash fluid comprises an anticoagulant.

### Embodiment 37

The method of any one of embodiments 1-36, wherein the wash fluid comprises an antiplatelet agent.

### Embodiment 38

The method of any one of embodiments 1-37, wherein the fixation fluid comprises formaldehyde or glutaraldehyde.

### Embodiment 39

The method of any one of embodiments 1-38, wherein the cryoprotection fluid comprises an aldehyde.

### Embodiment 40

The method of any one of embodiments 1-39, wherein the cryoprotection fluid comprises ethylene glycol, dimethyl sulfoxide, glycerol, or polyethylene glycol.

### Embodiment 41

The method of any one of embodiments 1-40, wherein the cryoprotection fluid has a vitrification temperature of about −195° C. to about +50° C.

### Embodiment 42

The method of any one of embodiments 1-41, wherein the tissue is preserved within 8 hours of the subject's death.

### Embodiment 43

The method of any one of embodiments 1-42, wherein the subject is a human.

### Embodiment 44

The method of any one of embodiments 1-42, wherein the subject is a non-human animal.

### Embodiment 45

The method of embodiment 44, wherein the non-human animal is a rodent.

### Embodiment 46

The method of any one of embodiments 1-45, wherein the tissue is an organ or a portion thereof.

### Embodiment 47

The method of any one of embodiments 1-46, wherein the tissue is a brain or a portion thereof.

### Embodiment 48

The method of any one of embodiments 1-47, wherein the volume of the tissue is about 100 cm³ or larger.

### Embodiment 49

The method of any one of embodiments 1-48, wherein the aqueous solution of the wash fluid is a saline solution.

### Embodiment 50

The method of any one of embodiments 1-49, wherein the aqueous solution of the wash fluid is a buffered saline solution.

### Embodiment 51

A preserved tissue formed according to the method of any one of embodiments 1-17 and 26-50.

### Embodiment 52

A fixation fluid for fixing a tissue by perfusion, comprising (1) an aldehyde, and (2) a dye or a contrast agent.

### Embodiment 53

The fixation fluid of embodiment 52, wherein the aldehyde is formaldehyde or glutaraldehyde.

### Embodiment 54

A cryoprotection fluid for cryopreserving a tissue, comprising (1) a vitrification agent, and (2) a dye or a contrast agent.

### Embodiment 55

The cryoprotection fluid of embodiment 54, wherein the cryoprotection fluid comprises an aldehyde.

### Embodiment 56

The cryoprotection fluid of embodiment 54 or 55, wherein the cryoprotection fluid comprises ethylene glycol, glycerol, dimethyl sulfoxide, polyethylene glycol.

### Embodiment 57

The cryoprotection fluid of any one of embodiments 54-56, wherein the cryoprotection fluid has a vitrification temperature of about −195° C. to about +50° C.

### Example

Thirteen liters of each of a washout solution, a fixative solution, and a cryoprotectant solution were prepared as follows. The washout solution contained 11,666.5 g distilled water and 1026.3 g of a 10× washout solution. The 10× washout solution contained 1026.3 g sodium chloride; 234.7 g sodium phosphate dibasic dihydrate, 35.8 g sodium phosphate monobasic dihydrate, 43.3 g potassium chloride, and 12,503.4 g distilled water. The fixative solution contained 2747.9 g of a 5× phosphate buffer solution, 845.0 g of a 50% glutaraldehyde solution, 1.3 g of sodium dodecyl sulfate (SDS), and 9646.0 g distilled water. The 5× phosphate buffer solution contained 952.2 g sodium phosphate dibasic dihydrate, 179.4 g sodium phosphate monobasic dihydrate, 6.0 g sodium azide, and 12,584.0 g distilled water. The cryoprotectant solution contained 2747.9 g 5× phosphate buffer solution, 845.0 g glutaraldehyde, 8450.0 ethylene glycol, and 2134.6 g distilled water.

A large scale perfusion machine similar to the device illustrated in FIG. 1 was assembled. The device included perfusate containers, a peristaltic pump (MasterFlex peristaltic pump (#7549-30) with an I/P easy-load head (#7529-20)), a Millipore 293 mm filter holder equipped with a 293 mm 0.22 micron nylon filter, a digital pressure sensor (Honeywell #SSCDANT030PASA5), and a laptop computer used to operate the device via an Arduino controller. The device further contained embalming cannulae connected to the peristaltic pump using a Y-junction and tubing.

Wash fluid was allowed to flow through the cannulae to remove air bubbles in the system before the cannulae were connected to the carotid arteries of a donated brain from an 86 year-old human female. Work was performed on the brain starting 2 hours and 45 minutes after death. The brain was removed from the skull using standard craniotomy techniques. Timing of the preservation procedure was as follows: about 15 minutes for surgical setup; about 20 minutes perfusion with the washout solution, about 1 hour perfusion with the fixation solution, about 6 hours gradient ramp from fixation solution to cryoprotectant solution, and about 1 hour perfusion with the cryoprotectant solution. The brain tissue showed browning color change upon glutaraldehyde fixation and infiltration with ethylene glycol.

The brain was sectioned into 0.5 inch (˜1.3 cm) coronal slabs. The 2 hour and 45 minute delay in perfusion prevented complete perfusion in certain areas of the brain, particularly the cerebellum due to the presence of several blood clots that impeded flow. The samples from the thalamus, hippocampus, and cortex were obtained using a vibratome and processed for electron microscopy or focused ion beam microscopy. The samples were processed using the techniques described in Graham-Knott et. Al, Focussed Ion Beam Milling and Scanning Electron Microscopy of Brain Tissue, J. Visualized Experiments, vol. 53, p. e2588 (2011).

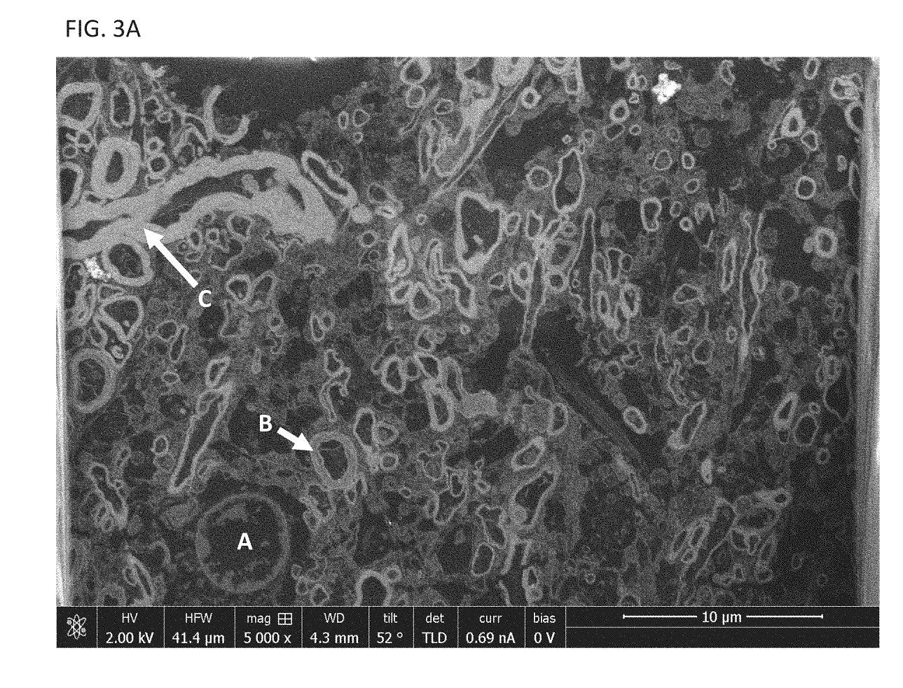

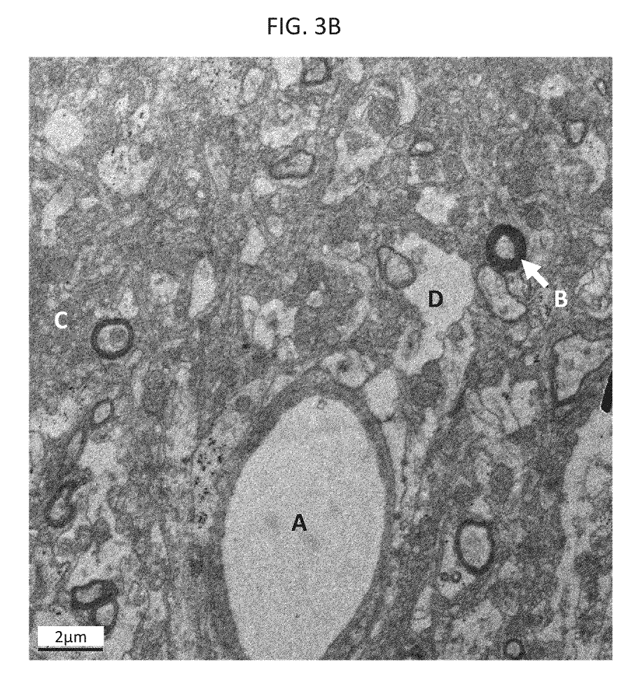

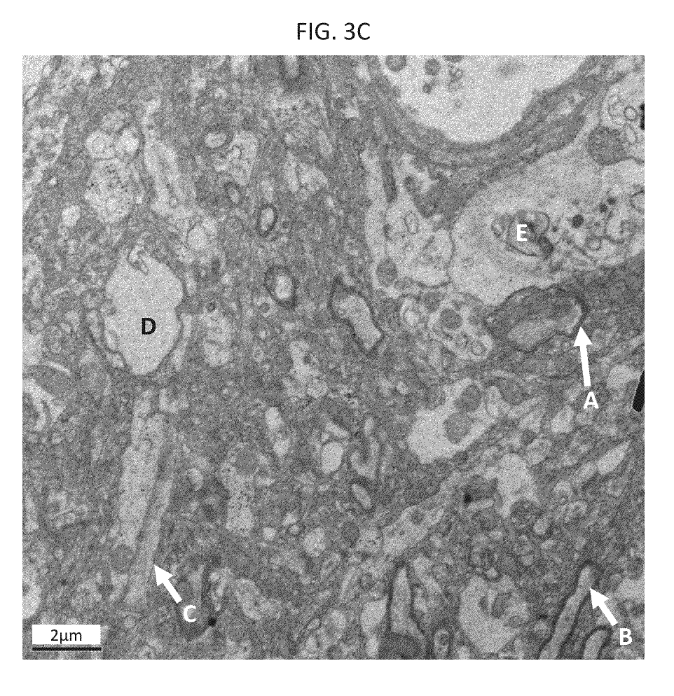

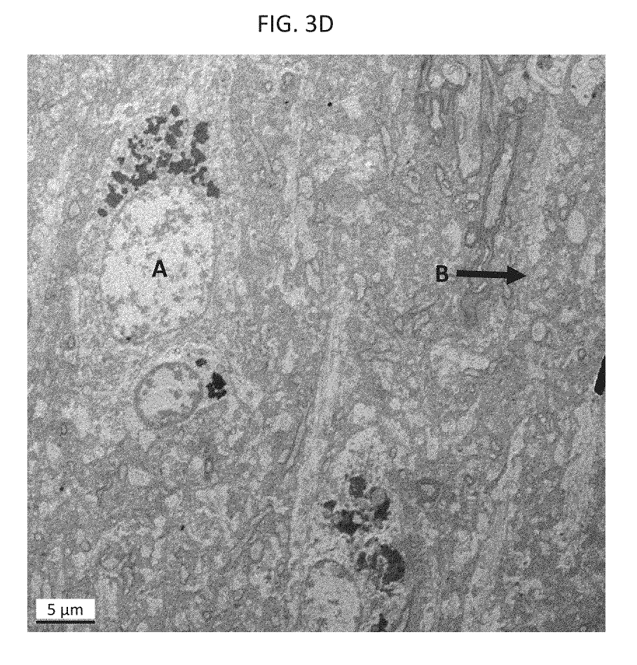

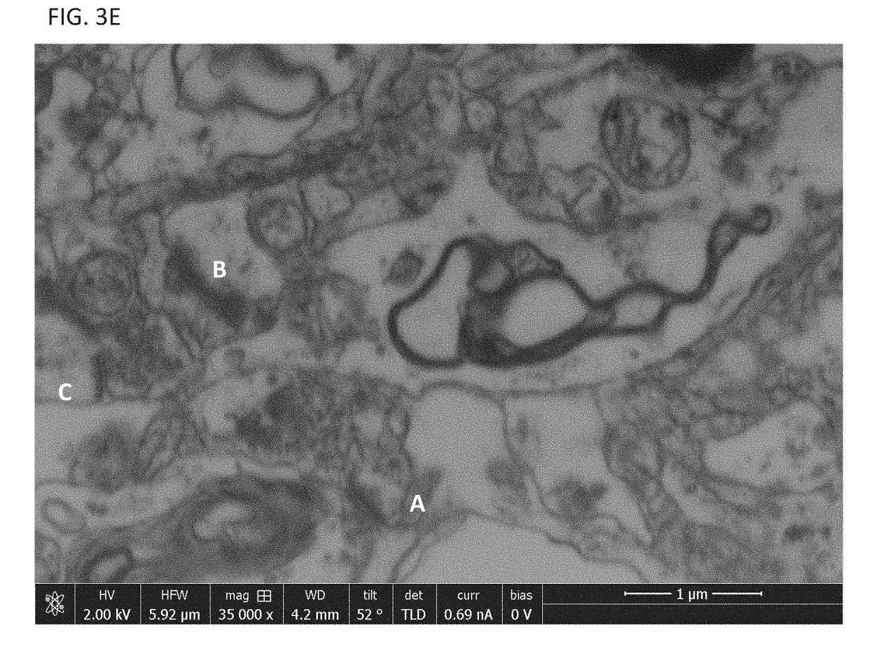

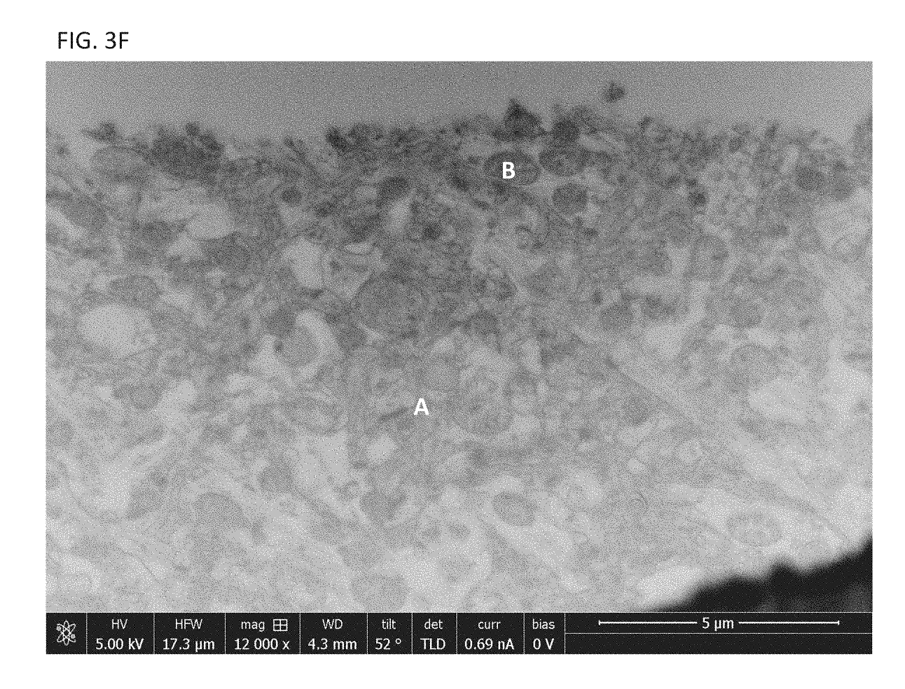

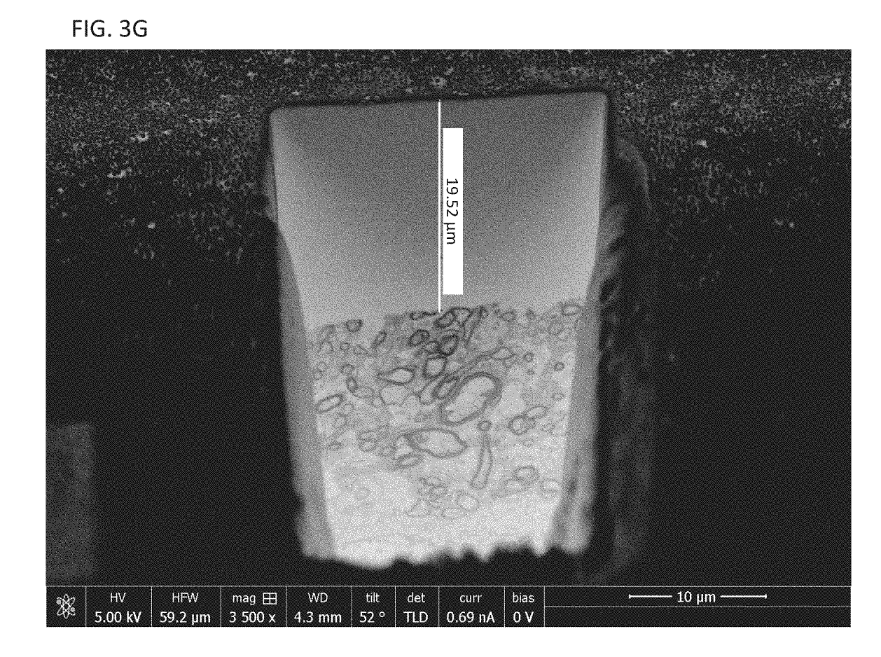

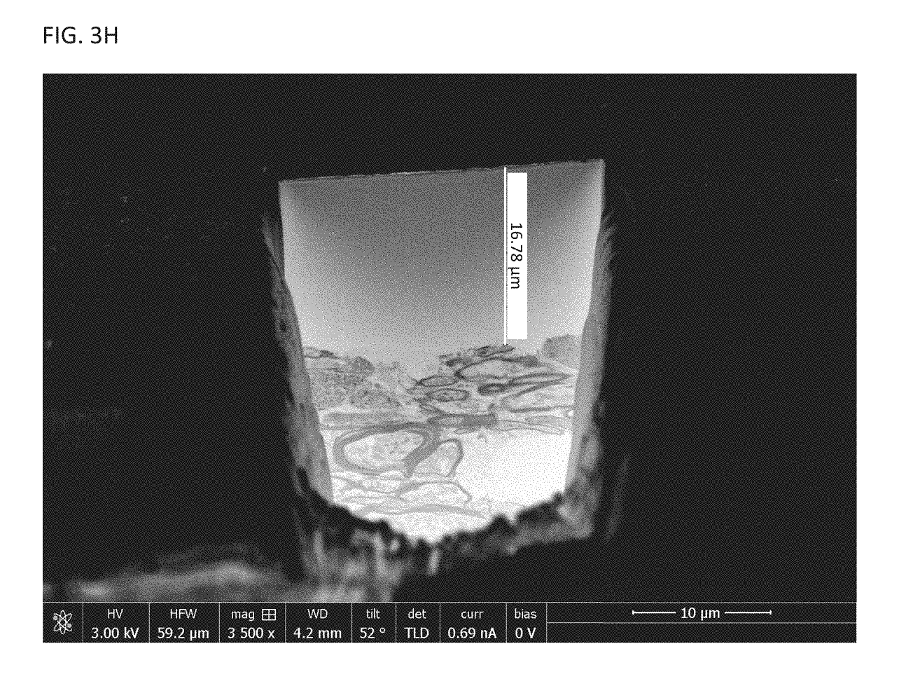

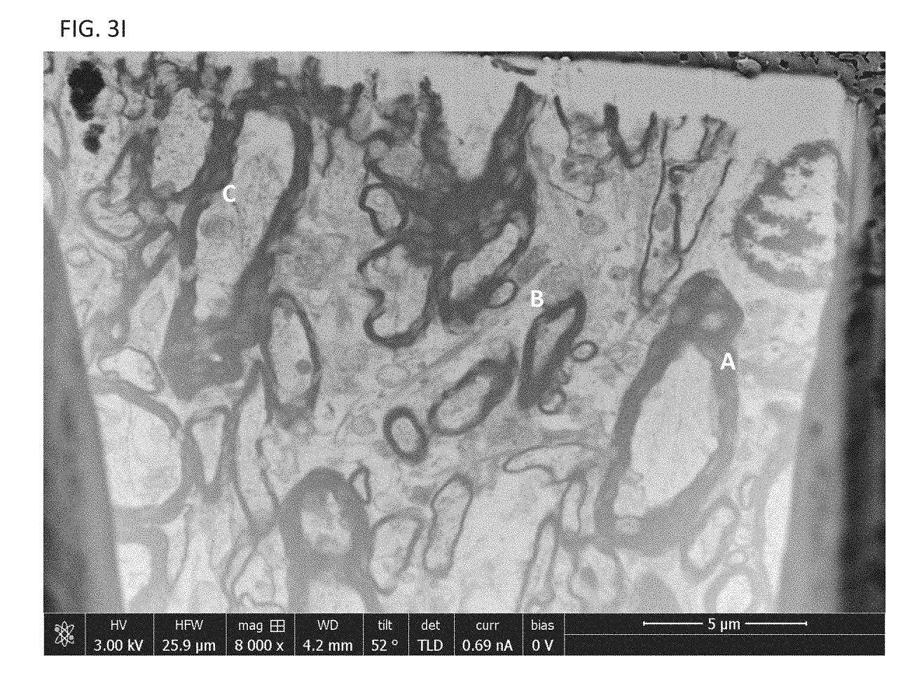

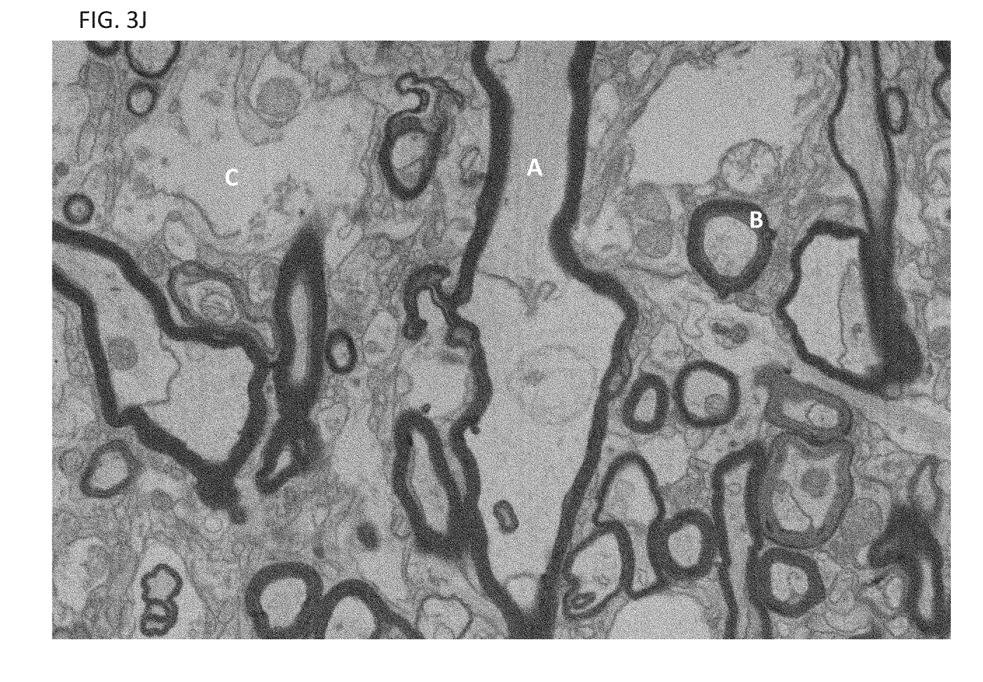

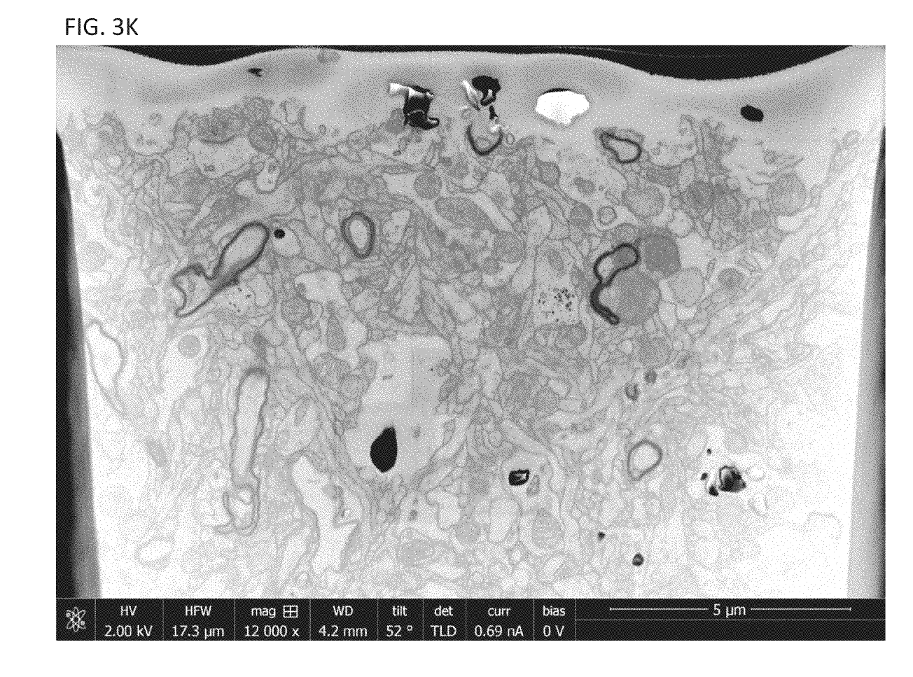

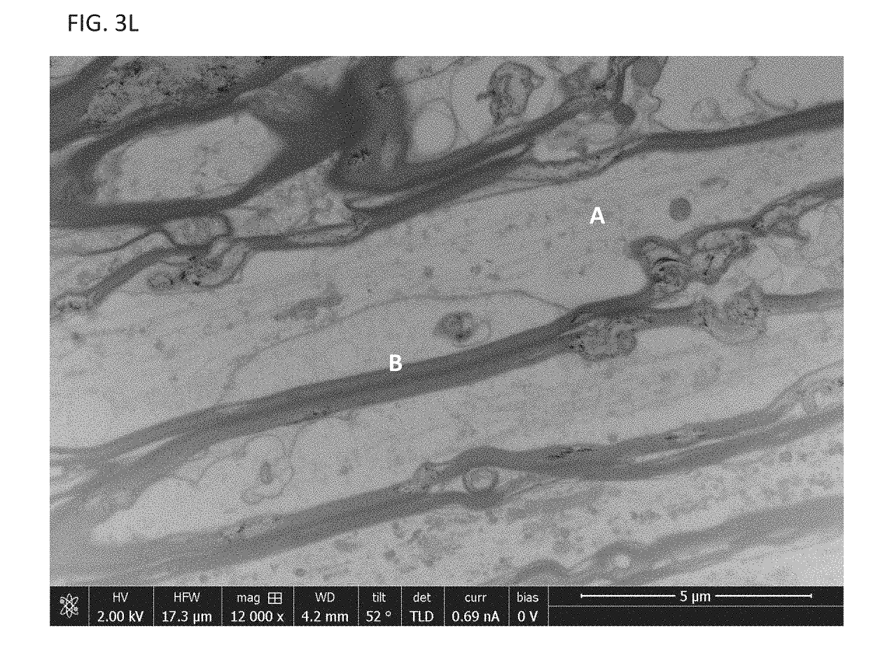

Electron microscopy demonstrated nanoscale preservation of brain tissue at an unprecedented degree. FIG. 3A shows an inverted contrast image from a cortex sample, which shows good preservation and high retention of nuclear material (A) and myelin (B, C). FIG. 3B is an electron microscopy image of a cortex sample, showing a blood vessel (A), multiple processes (i.e., multiple branches of the neuron) (B), and well preserved ground substance (C). Some damage (D) was also visible. FIG. 3C shows an additional electron microscopy image of a cortex sample with well-preserved synapses (A), myelinated processes (B), unmylenated processes (C), and some damaged areas (D, E). FIG. 3D is an electron microscopy image showing multiple pyramidal cells (A) and multiple myelinated processes (B). FIG. 3E shows multiple synapses (A, B, C) within the uranium acetate stained cortex sample obtained using scanning electron microscopy. FIG. 3F is an electron microscopy image of an amygdala, showing multiple synapses (A) and fine processes, as well as several expanded mitochondria (B). FIG. 3G is a focused ion beam milling image of a cortex sample coated with a 20 micrometer layer of resin milled to reveal the brain tissue. FIG. 3H is a focused ion beam milling image of a corpus callosum sample coated with a layer of resin milled to reveal the brain tissue. FIG. 3I is an electron microscopy image of a uranium acetate stained cortex that shows myelin and partially-disrupted incisures (A, B, C). FIG. 3J is a focused ion beam scanning electron microcopy (FIB-SEM) image of a hippocampus sample showing well preserved myelinated processes (A, B). FIG. 3K shows an image from a cortex sample within a resin block. Although the preservation of brain tissue is better preserved than previous studies, some damage to the brain ultrastructure was observed. For example, in FIG. 3J, some loss of intracellular components were observed (C). FIG. 3L is an electron microscopy image of a uranium acetate stained cortex sample showing disrupted myelin (A) in several parallel processes, as well as normal myelin (B).

1. A method of preserving a tissue of a subject, comprising
washing the tissue by perfusing the tissue with a wash fluid comprising an aqueous solution;
fixing the tissue by perfusing the tissue with a fixation fluid comprising an aldehyde; and
cryoprotecting the tissue by perfusing the tissue with a cryoprotection fluid comprising a vitrification agent;
wherein the washing is initiated after onset of ischemia in the tissue.

2. A method of preserving a tissue of a subject, comprising
washing the tissue by perfusing the tissue with a wash fluid comprising an aqueous solution;
fixing the tissue by perfusing the tissue with a fixation fluid comprising an aldehyde; and
cryoprotecting the tissue by perfusing the tissue with a cryoprotection fluid comprising a vitrification agent;
the wash fluid, the fixing fluid, or the cryoprotection fluid comprising a dye or a contrast agent.

3. A method of preserving a tissue of a subject, comprising
washing the tissue by perfusing the tissue with a wash fluid comprising an aqueous solution;
fixing the tissue by perfusing the tissue with a fixation fluid comprising an aldehyde; and
cryoprotecting the tissue by perfusing the tissue with a cryoprotection fluid comprising a vitrification agent, the cryoprotection fluid having a vitrification temperature of about −80° C. or higher.

4. A method of preserving a tissue of a subject, comprising
washing the tissue by perfusing the tissue with a wash fluid comprising (1) an aqueous solution, and (2) any one or more of an ion channel blocker, a calcium chelator, a thrombolytic agent, an anti-platelet, a respiratory poison, or a synaptic poison;
fixing the tissue by perfusing the tissue with a fixation fluid comprising an aldehyde; and
cryoprotecting the tissue by perfusing the tissue with a cryoprotection fluid comprising a vitrification agent.

5. The method of claim 1, wherein the wash fluid, the fixation fluid, or the cryoprotection fluid comprises a dye or a contrast agent.

6. The method of claim 1, wherein the wash fluid, the fixation fluid, or the cryoprotection fluid comprises a radiopaque dye.

7. The method of claim 1, further comprising monitoring by imaging a distribution of the wash fluid, the fixation fluid, or the cryoprotection fluid in the tissue.

8. The method of claim 7, wherein the monitoring is performed by computed tomography (CT), micro computed tomography (microCT), X-Ray, or MRI.

9. The method of claim 1, wherein perfusion of the tissue with the wash fluid, the fixation fluid, or the cryoprotection fluid is performed according to a perfusion schedule, wherein the perfusion schedule is modified based on the monitored distribution of the wash fluid, the fixation fluid, or the cryoprotection fluid.

10. The method of claim 1, further comprising vitrifying the tissue.

11. The method of claim 10, wherein the tissue is vitrified to a temperature of about −100° C. or colder.

12. The method of claim 10, comprising storing the vitrified tissue for about 72 hours or longer.

13. The method of claim 10, comprising thawing the vitrified tissue.

14. The method of claim 1, comprising imaging at least a portion of the preserved tissue.

15. The method of claim 1, comprising characterizing at least a portion of the preserved tissue through a microanatomical analysis.

16. The method of claim 1, wherein at least a portion of the preserved tissue is imaged using electron microscopy, expansion microscopy, or fluorescence in situ hybridization (FISH) expansion microscopy.

17. The method of claim 1, wherein the cryoprotection fluid is perfused into the tissue as a gradient against the fixation fluid.

18. The method claim 1, wherein the wash fluid, the fixation fluid, or the cryoprotection fluid comprises an ion channel blocker or an ion receptor blocker.

19. The method of claim 1, wherein the wash fluid, the fixation fluid, or the cryoprotection fluid comprises a calcium chelator.

20. The method of claim 1, wherein the wash fluid, the fixation fluid, or the cryoprotection fluid comprises a respiratory poison.

21. The method of claim 1, wherein the wash fluid, the fixation fluid, or the cryoprotection fluid comprises a synaptic poison.

22. The method of claim 1, wherein the wash fluid, the fixation fluid, or the cryoprotection fluid comprises a vasodilator.

23. The method claim 1, wherein the wash fluid, the fixation fluid, or the cryoprotection fluid comprises an oncotic agent.

24. The method of claim 1, wherein the wash fluid or the fixation fluid comprises an ionic surfactant.

25. The method claim 1, wherein the wash fluid comprises an anesthetic.

26. The method of claim 1, wherein the wash fluid comprises a thrombolytic agent.

27. The method of claim 1, wherein the wash fluid comprises an anticoagulant.

28. The method of claim 1, wherein the wash fluid comprises an antiplatelet agent.

29. The method of claim 1, wherein the fixation fluid comprises formaldehyde or glutaraldehyde.

30. The method of claim 1, wherein the cryoprotection fluid comprises an aldehyde.

31. The method claim 1, wherein the cryoprotection fluid comprises ethylene glycol, dimethyl sulfoxide, glycerol, or polyethylene glycol.

32. The method of claim 1, wherein the cryoprotection fluid has a vitrification temperature of about −195° C. to about +50° C.

33. The method of claim 1, wherein the tissue is preserved within 8 hours of the subject's death.

34. The method of claim 1, wherein the subject is a human.

35. The method of claim 1, wherein the subject is a non-human animal.

36. The method of claim 35, wherein the non-human animal is a rodent.

37. The method of claim 1, wherein the tissue is an organ or a portion thereof.

38. The method of claim 1, wherein the tissue is a brain or a portion thereof.

39. The method of claim 1, wherein the volume of the tissue is about 100 cm³ or larger.

40. The method of claim 1, wherein the aqueous solution of the wash fluid is a saline solution.

41. The method of claim 1, wherein the aqueous solution of the wash fluid is a buffered saline solution.

42. A preserved tissue formed according to the method of claim 1.
